(19) United States
(12) Patent Application Publication
(10) Pub. No.: US 2024/0407390 A1
(43) Pub. Date: Dec. 12, 2024

(54) SYSTEMS AND METHODS FOR FORMING COMPACTED MYCELIUM PRODUCTS

(71) Applicant: Emergy Inc., Boulder, CO (US)

(72) Inventors: Russel MEIGS, Lafayette, CO (US); Edward John HAMRICH, Arvada, CO (US); Justin WHITELEY, Lafayette, CO (US); Tracy B. YATES, Arvada, CO (US)

(21) Appl. No.: 18/694,888

(22) PCT Filed: Sep. 23, 2022
(86) PCT No.: PCT/US2022/044596

§ 371 Date: Mar. 22, 2024

Related U.S. Application Data
(60) Provisional application No. 63/247,652, filed on Sep. 23, 2021.
(60) Provisional application No. 63/247,654, filed on Sep. 23, 2021.

(51) Int. Cl. A23J 3/22; A23J 3/20; A23L 31/00

(52) U.S. Cl. CPC A23J 3/227; A23J 3/20; A23L 31/00

(57) ABSTRACT

An apparatus for forming an edible meat substitute includes a vessel configured to receive a diluted mycelium product and pressurize the diluted mycelium product. The apparatus further includes a conduit coupled to an outlet of the vessel and a first mold fluidly coupled to the outlet of the vessel via the conduit. The apparatus further includes a first valve coupled to the conduit and configured to be selectively opened to expel the pressurized diluted mycelium product into the first mold.

### TECHNICAL FIELD

This application claims the benefit of U.S. Provisional Application No. 63/247,654, filed on Sep. 23, 2021, and of U.S. Provisional Application No. 63/247,652, filed on Sep. 23, 2021, the contents of each of which are incorporated herein by reference in their entirety.

The present disclosure relates generally to the field of fungal mycelium based edible meat substitute products.

### BACKGROUND

Demand for edible products that can provide a high protein content which is drawn from a non-animal source is increasing. Driven by increasing awareness of personal health, edible products that include non-animal sourced components such as proteins and fibers are considered as a healthier alternative to animal protein-based products. In particular, there is growing demand for edible meat substitutes that mimic meat in its composition and texture but are composed of non-animal components, which can reduce reliance on animals such as cows, chicken, and pigs, and reduce the carbon footprint posed by such animals. Thus, there is a need for non-animal protein sources that can facilitate large scale production and adoption of non-animal based edible products.

### SUMMARY

Embodiments described herein relate generally to the systems and methods for forming a compacted mycelium product for obtaining edible meat substitute products that resemble animal meat in their texture and morphology.

In some embodiments, an apparatus for forming an edible meat substitute includes a vessel configured to receive a diluted mycelium product and pressurize the diluted mycelium product. The apparatus further includes a conduit coupled to an outlet of the vessel. The apparatus further includes a first mold fluidly coupled to the outlet of the vessel via the conduit. The apparatus further includes a first valve coupled to the conduit and configured to be selectively opened to expel the pressurized diluted mycelium product into the first mold.

In another embodiment, a system of forming an edible meat substitute includes a product supply manifold. The system further includes a first vessel configured to receive first diluted mycelium product from the product supply mold. The system further includes a second vessel configured to receive a second diluted mycelium product from the product supply manifold. The system further includes a gas supply manifold configured to provide pressurized gas to the first vessel and the second vessel so as to pressurize the first diluted mycelium product and the second diluted mycelium product, respectively. The system further includes a first mold fluidly coupled to the first vessel via a first vessel first valve and a second mold fluid coupled to the second vessel via a second vessel first valve. The first vessel first valve and the second vessel first valve are configured to be selectively opened to communicate the pressurized first diluted mycelium product into the first mold and the pressurized second diluted mycelium product into the second mold, respectively.

In yet another embodiment, a method of forming an edible meat substitute product includes providing a mycelium mass having a first volume and diluting the mycelium mass with water having a water volume so as to form a diluted mycelium product. In some embodiments, a ratio of the water volume to the first volume is in a range from about 0.3:1 to about 19.5:1. In some embodiments, a ratio of the water volume to the first volume is in a range from about 0.35:1 to about 19.5:1. In some embodiments, a ratio of the water volume to the first volume is in a range from about 0.35:1 to about 19:1. In some embodiments, a ratio of the water volume to the first volume is in a range from about 0.3:1 to about 19:1. In some embodiments, a ratio of the water volume to the first volume is in a range from about 1:1 to about 5:1. In some embodiments, a ratio of the water volume to the first volume is in a range from about 0.5:1 to about 5:1. In some embodiments, the mycelium mass is a nutritionally enhanced mycelium product including Vitamin D and/or iron. In some embodiments, the mycelium mass is a nutritionally enhanced mycelium product having a vitamin D content of greater than 1 μg per 100 grams of the enhanced mycelium product and/or an iron content greater than or equal to 5 mg of iron per 100 g of mycelium mass. In some embodiments, the mycelium mass has an iron content of from about 5 mg of iron per 100 g of mycelium mass to about 15 mg of iron per 100 g of mycelium mass and a vitamin D content that may be in a range of greater than about 1 microgram per 100 grams of the enhanced mycelium product. The method further includes applying a pressure to the diluted mycelium product. The diluted mycelium product is disposed within a vessel. The method further includes selectively expelling the diluted mycelium product from the vessel into a mold and expelling water from the diluted mycelium product to form a compacted mycelium product.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a flow chart of a method for forming a compacted mycelium product with a mold filler, according to an embodiment.

FIG. 2 is a schematic illustration of a mold filler system, according to an embodiment.

FIG. 3 is a schematic illustration of a mold filler system with more than one mold, according to an embodiment.

FIG. 4 is a schematic illustration of a mold filler system with more than one vessel and more than one mold, according to an embodiment.

FIG. 5 is a perspective view of a mycelium block obtained by the method of FIG. 1.

FIG. 6A is a perspective view of a mold with a perforated base, according to an embodiment.

FIG. 6B illustrates a perspective view of a mold with a perforated base and perforated sidewalls, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for forming a compacted mycelium product for obtaining an edible meat substitute product that resembles animal meats in their texture and morphology. Particularly, various embodiments described herein are related to a system that includes a pressurized vessel configured to receive a diluted mycelium product, a conduit coupled to an outlet of the vessel, a mold fluidly coupled to the outlet of the vessel via the conduit, and a valve configured to selectively expel the pressurized diluted mycelium product into the mold via the conduit. Applying pressure to the diluted mycelium product in the vessel may allow for the mycelium product to be expelled into a mold. A unidirectional pressure may allow for the alignment of the mycelium fibers and may result in a more homogenous mycelium product. The applied pressure may be pneumatic pressure. The applied pressure may be provided by mechanical force or gravity. The mold may allow for the mycelium product to expel any excess water and to form into any desirable and more homogenous shape. Various embodiments also relate to adding food additives to a mycelium mass to form an edible food product or edible meat substitute product. In some embodiments, the mycelium mass is a nutritionally enhanced mycelium product including Vitamin D and/or iron. In some embodiments, the mycelium mass is a nutritionally enhanced mycelium product having a vitamin D content of greater than 1 μg per 100 grams of the enhanced mycelium product and/or an iron content greater than or equal to 5 mg of iron per 100 g of mycelium mass. In some embodiments, the mycelium mass has an iron content of from about 5 mg of iron per 100 g of mycelium mass to about 15 mg of iron per 100 g of mycelium mass.

Various embodiments of the systems and methods of forming a compacted mycelium product with a pneumatic mold filler press may provide one or more benefits including, for example: (1) expelling excess moisture from the mycelium product; (2) forming shapes that take the form of animal meats such as chicken breasts, beef steaks, pork chops, etc.; (3) making the mycelium product more homogenous by diluting it; (4) aligning the mycelium fibers due to a unidirectional force; (5) providing a quicker process; (6) providing a more scalable process; (7) providing a more economical process; and (8) filling multiple molds simultaneously with one batch of mycelium product.

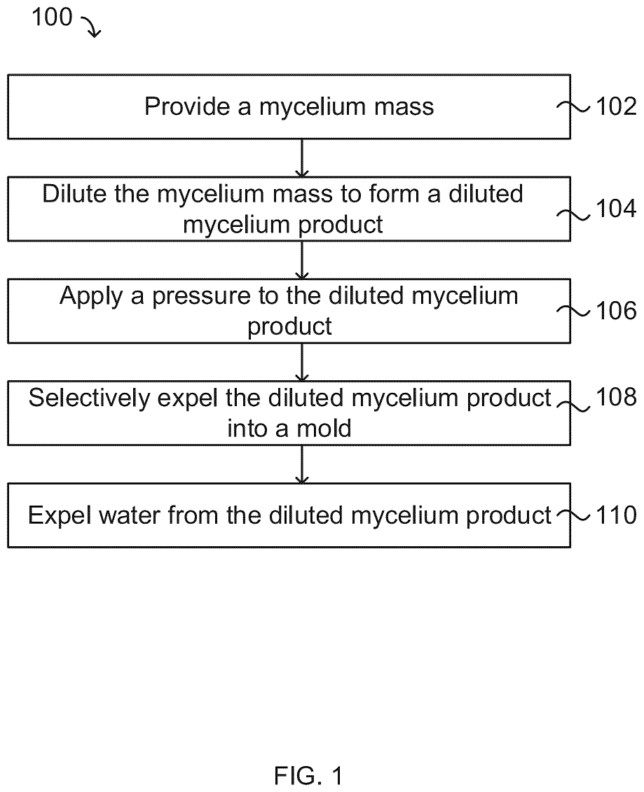

FIG. 1 illustrates a block diagram of an example method 100 for forming an edible meat substitute product, according to an embodiment. In a brief overview, the method 100 may include providing a mycelium mass, at 102. The method 100 may include diluting the mycelium mass to form a diluted mycelium product, at 104. The method 100 may include applying a pressure to the diluted mycelium product, at 106. The method 100 may include selectively expelling the diluted mycelium product into a mold, at 108. The method 100 may include expelling water from the diluted mycelium product.

In further detail, the method 100 may include providing a mycelium mass, at 102. The mycelium mass has a first volume. The mycelium mass may be fungal mycelium and can include fungi from Ascomycota and Zygomycota, including the genera Aspergillus, Fusarium, Neurospora, and Monascus. Other species include edible varieties of division Basidiomycota and generus Lentinula. One genus is Neurospora, which is used in food production through solid fermentation. The genus of Neurospora are known for highly efficient biomass production as well as ability to break down complex carbohydrates. For certain species of Neurospora, no known allergies have been detected and no levels of mycotoxins are produced. In some embodiments, the fungal mycelium comprises fungi in from the genus Neurospora. In some embodiments, the fungal mycelium consists of fungi from the genus Neurospora. In some embodiments, the fungal mycelium comprises fungi from the species Neurospora crassa. In some embodiments, the fungal mycelium consists of fungi from the species Neurospora crassa. In addition to monocultures of filamentous fungi, multiple strains can be cultivated at once to tune the protein, amino acid, mineral, texture, and flavor profiles of the final biomass. The aforementioned species of fungi do not inherently have vitamin D.

Methods of growing fungal cells to produce mycelium are known in the art and include, as non-limiting examples, methods described in U.S. Patent Application Publication No. US 2019/0373935 A1 (entitled “METHOD FOR GROWING FUNGAL MYCELIUM AND FORMING EDIBLE PRODUCTS THEREFROM”), which is herein incorporated by reference, specifically in the passages reproduced below.

In one example, Neurospora crassa (N. crassa) was grown in batch configuration in a 10 L benchtop reactor. N. crassa is first grown on agar slants and incubated for 3 days at 32° C. Conidia or spores of the N. crassa are transferred to a 250 mL vented Fernbach flask and grown for 48 hours on an orbital shaker table at 32° C. The resulting mycelium is aseptically transferred to a benchtop 10 L reactor containing the following media: 20 g/L sucrose, 2 g/L ammonium nitrate, 2 g/L potassium phosphate monobasic, 1 g/L sodium nitrate, 0.2 g/L magnesium sulfate, 0.1 g/L calcium chloride, and trace elements. Aeration is set at 0.75 vvm and agitation at 250 rpm. The pH is adjusted and held at 5.8 using a 6 N sodium hydroxide buffer. After 24 hours, the mycelium is harvested using a cheese cloth, dewatered in a cider press, and completely dried in a dehydrator set at 74° C. The total cell dry weight is 9.5 g/L. Protein analysis yields a crude protein content of 57 wt %. Amino acid analysis yields a PDCAAS score of 1.0 for the fibrous mycelium mass. The fibrous mycelium mass has a combined methionine and cysteine content of 26 mg/g crude protein.

In another example, N. crassa was grown in batch configuration in a 10 L benchtop reactor. N. crassa is first grown on agar slants and incubated for 3 days at 32° C. Conidia or spores of the N. crassa are transferred to a 250 mL vented Fernbach flask and grown for 48 hours on an orbital shaker table at 32° C. The resulting mycelium is aseptically transferred to a benchtop 10 L reactor containing the following media: 20 g/L sucrose, 2 g/L ammonium nitrate, 1 g/L potassium phosphate monobasic, 0.2 g/L magnesium sulfate, 0.1 g/L calcium chloride, and trace elements. Acration is set at 0.75 vvm and agitation at 250 rpm. The pH is adjusted and held at 5.8 using a 6 N sodium hydroxide buffer. After 24 hours, the mycelium is harvested using a cheese cloth, dewatered in a cider press, and completely dried in a dehydrator set at 74° C. The total cell dry weight is 9 g/L. Protein analysis yields a crude protein content of 55 wt %. Amino acid analysis yields a PDCAAS score of 1.0 for the fibrous mycelium mass. The fibrous mycelium mass has a combined methionine and cysteine content of 26 mg/g crude protein.

In another example, N. crassa was grown in batch configuration in a 10 L benchtop reactor. N. crassa is first grown on agar slants and incubated for 3 days at 32° C. The conidia is transferred to a 250 mL vented Fernbach flask and grown for 48 hours on an orbital shaker table at 32° C. The resulting mycelium is aseptically transferred to a benchtop 10 L reactor containing the following media: 30 g/L sucrose, 3 g/L ammonium nitrate, 1 g/L potassium phosphate monobasic, 0.2 g/L magnesium sulfate, 0.1 g/L calcium chloride, and trace elements. Acration is set at 0.75 vvm and agitation at 250 rpm. The pH is adjusted and held at 5.8 using a 6 N sodium hydroxide buffer. After 24 hours, the mycelium is harvested using a cheese cloth, dewatered in a cider press, and completely dried in a dehydrator set at 74° C. The total cell dry weight is 11 g/L. Protein analysis yields a crude protein content of 63 wt %. Amino acid analysis yields a PDCAAS score of 1.0 for the fibrous mycelium mass. The fibrous mycelium mass has a combined methionine and cysteine content of 27 mg/g crude protein.

In another example, N. crassa was grown in batch configuration in a 10 L benchtop reactor. N. crassa is first grown on agar slants and incubated for 3 days at 32° C. The conidia is transferred to a 250 mL vented Fernbach flask and grown for 48 hours on an orbital shaker table at 32° C. The resulting mycelium is aseptically transferred to a benchtop 10 L reactor containing the following media: 20 g/L sucrose, 3.25 g/L urea, 1 g/L potassium phosphate monobasic, 0.2 g/L magnesium sulfate, 0.1 g/L calcium chloride, and trace elements. Acration is set at 0.75 vvm and agitation at 250 rpm. The pH is adjusted and held at 5.8 using a 6 N sodium hydroxide buffer. After 24 hours, the mycelium is harvested using a cheese cloth, dewatered in a cider press, and completely dried in a dehydrator set at 74° C. The total cell dry weight is 8.5 g/L. Protein analysis yields a crude protein content of 56 wt %. Amino acid analysis yields a PDCAAS score of 1.0. The fibrous mycelium mass has a combined methionine and cysteine content of 25 mg/g crude protein.

In another example, N. crassa was grown in batch configuration in a 10 L benchtop reactor. N. crassa is first grown on agar slants and incubated for 3 days at 32° C. The conidia is transferred to a 250 mL vented Fernbach flask and grown for 48 hours on an orbital shaker table at 32° C. The resulting mycelium is aseptically transferred to a benchtop 10 L reactor containing the following media: 20 g/L sucrose, 2 g/L ammonium nitrate, 1 g/L potassium phosphate monobasic, 0.2 g/L magnesium sulfate, 0.1 g/L calcium chloride, and trace elements. Aeration is set at 0.75 vvm and agitation at 250 rpm. The pH is adjusted and held at 5.8 using a 15% ammonium hydroxide buffer. After 24 hours, the mycelium is harvested using a cheese cloth, dewatered in a cider press, and completely dried in a dehydrator set at 74° C. The total cell dry weight is 10 g/L. Protein analysis yields a crude protein content of 60 wt %. Amino acid analysis yields a PDCAAS score of 1.0. The fibrous mycelium mass has a combined methionine and cysteine content of 26 mg/g crude protein.

In another example, N. crassa was grown in batch configuration in a 10 L benchtop reactor. N. crassa is first grown on agar slants and incubated for 3 days at 32° C. The conidia is transferred to a 250 mL vented Fernbach flask and grown for 48 hours on an orbital shaker table at 32° C. The resulting mycelium is aseptically transferred to a benchtop 10 L reactor containing the following media: 20 g/L sucrose, 2 g/L ammonium nitrate, 1 g/L potassium phosphate monobasic, 0.2 g/L magnesium sulfate, 0.1 g/L calcium chloride, and trace elements. Aeration is set at 0.75 vvm and agitation at 250 rpm. The pH is adjusted and held at 5.8 using a 6 N sodium hydroxide buffer. After 12 hours, 10 g/L sucrose and 1 g/L ammonium nitrate is added to the system. After 24 hours total, the mycelium is harvested using a cheese cloth, dewatered in a cider press, and completely dried in a dehydrator set at 74° C. The total cell dry weight is 12 g/L. Protein analysis yields a crude protein content of 60 wt %. Amino acid analysis yields a PDCAAS score of 1.0 for the fibrous mycelium mass. The fibrous mycelium mass has a combined methionine and cysteine content of 26 mg/g crude protein.

In another example, N. crassa was grown in batch configuration in a 10 L benchtop reactor. N. crassa is first grown on agar slants and incubated for 3 days at 32° C. The conidia is transferred to a 250 mL vented Fernbach flask and grown for 48 hours on an orbital shaker table at 32° C. The resulting mycelium is aseptically transferred to a benchtop 10 L reactor containing the following media: 20 g/L sucrose, 2 g/L ammonium nitrate, 1 g/L potassium phosphate monobasic, 0.2 g/L magnesium sulfate, 0.1 g/L calcium chloride, and trace elements. Acration is set at 0.75 vvm and agitation at 250 rpm. The pH is adjusted and held at 5.8 using a 6 N sodium hydroxide buffer. After 24 hours, 90% of the media is harvested; new media is added in the concentrations of above to bring the total system back to 10 L. The new sequential batch time is reduced to 12 hours. Every 12 hours 90% is harvested and the fed-batch process is repeated again. The process was carried out for 60 hours. The harvested cell dry weight is 9.5 g/L. Protein analysis yields a crude protein content of 60 wt %. Amino acid analysis yields a PDCAAS score of 1.0 for the fibrous mycelium mass. The fibrous mycelium mass has a combined methionine and cysteine content of 26 mg/g crude protein.

In another example, N. crassa was grown in batch configuration in a 10 L benchtop reactor. N. crassa is first grown on agar slants and incubated for 3 days at 32° C. The conidia is transferred to a 250 mL vented Fernbach flask and grown for 48 hours on an orbital shaker table at 32° C. The resulting mycelium is aseptically transferred to a benchtop 10 L reactor containing the following media: 20 g/L sucrose, 2 g/L ammonium nitrate, 1 g/L potassium phosphate monobasic, 0.2 g/L magnesium sulfate, 0.1 g/L calcium chloride, and trace elements. Acration is set at 0.75 vvm and agitation at 250 rpm. The pH is adjusted and held at 5.8 using a 6 N sodium hydroxide buffer. After 24 hours, 90% of the media is harvested; new media is added in the concentrations of above to bring the total system back to 10 L. The new sequential batch time is reduced to 12 hours. Every 12 hours 90% is harvested and the fed-batch process is repeated again. The process was carried out for 60 hours. Following straining with cheese cloth and pressing, all media is collected, autoclaved and reused by only adding 20 g/L sucrose, 2 g/L ammonium nitrate, and 1 g/L potassium phosphate monobasic. The repeated fed-batch process is carried out for 60 hours total. The harvested cell dry weight is 9.5 g/L. Protein analysis yields a crude protein content of 60 wt %. Amino acid analysis yields a PDCAAS score of 1.0 for the fibrous mycelium mass. The fibrous mycelium mass has a combined methionine and cysteine content of 26 mg/g crude protein.

The fungal cells may be grown to produce mycelium in a growth media which may include nutrients such as sugar, a nitrogen-containing compound, and a phosphate-containing compound in a broth. The sugar can be in the range of about 5 to about 50 g/L (e.g., 5 g/L, 10 g/L, 20 g/L, 30 g/L, 40 g/L, or 50 g/L, inclusive). The sugar can include sucrose, glucose, fructose, molasses, or a mixture of sugars. The nitrogen-containing compound can be in the range of about 0.5 to about 10 g/L (e.g., 0.5 g/L, 1 g/L, 2 g/L, 3 g/L, 4 g/L, 5 g/L, or 10 g/L, inclusive). The nitrogen-containing compound can include ammonium hydroxide, ammonium nitrate, ammonium sulfate, ammonium chloride, urea, yeast extract, peptone, or a mixture of nitrogen-containing compounds. The phosphate-containing compound can be in the range of about 0.1 to about 5 g/L (e.g., 0.1 g/L, 0.2 g/L, 0.3 g/L, 0.4 g/L, 0.5 g/L, 1 g/L, 2 g/L, 3 g/L, 4 g/L, or 5 g/L, inclusive). The phosphate-containing compound can be potassium phosphate, sodium phosphate, phosphoric acid, or a mixture of phosphate-containing compounds.

In some embodiments, methods of growing fungal cells to produce mycelium include providing a first growth media having a first iron amount in a range from 0.1 mg/L to 10 mg/L. The methods may include growing fungal cells in the first growth media so as to produce a mycelium mass having an iron content. The methods may include separating the mycelium mass from the first growth media. In further detail, the methods may include providing a first growth media having a first iron amount in a range from 0.1 mg/L to 10 mg/L, at 202. The first growth media may have a first iron amount in a range from about 0.1 to about 10 mg/L (e.g., 0.1 mg/L, 1 mg/L, 2 mg/L, 3 mg/L, 4 mg/L, 5 mg/L, 6 mg/L, 7 mg/L, 8 mg/L, 9 mg/L, or 10 mg/L, inclusive). In some embodiments, the first iron amount is in a range from about 0.1 to 2 mg/L (e.g., 0.1 mg/L, 0.2 mg/L, 0.3 mg/L, 0.4 mg/L, 0.5 mg/L, 0.6 mg/L, 0.7 mg/L, 0.8 mg/L, 0.9 mg/L, 1 mg/L, 1.1 mg/L, 1.2 mg/L, 1.3 mg/L, 1.4 mg/L, 1.5 mg/L, 1.6 mg/L, 1.7 mg/L, 1.8 mg/L, 1.9 mg/L, or 2 mg/L, inclusive). The first iron amount may be adjusted according to the desired iron content. The first iron amount may be provided by any suitable iron-containing material, for example, iron salts (e.g., ferric citrate, ferrous sulfate, ferrous gluconate, ferrous fumarate, ferric sulfate, ammonium ion sulfate, heme iron polypeptides, carbonyl iron, etc.).

Growing the mycelium mass in a first growth media with an increased iron content may allow the mycelium mass to accumulate the iron intracellularly so as to boost the iron content of the mycelium mass without fortification with added salts or additives after the final product has been formed. In some embodiments, the mycelium mass may meet or exceed the RDA for iron, which is 8 milligrams/day for men, for women aged 19-50 years is 18 milligrams/day, and for women aged 51 and older is 8 milligrams/day. In some embodiments, increasing the first iron amount in the first growth media will increase the iron content of the mycelium mass without impacting growth rate.

In some embodiments, a second growth media may be added to the mycelium mass with a second iron amount in a range from about 0.1 to about 10 mg/L (e.g., 0.1 mg/L, 1 mg/L, 2 mg/L, 3 mg/L, 4 mg/L, 5 mg/L, 6 mg/L, 7 mg/L, 8 mg/L, 9 mg/L, or 10 mg/L, inclusive). In some embodiments, the second iron amount is in a range from about 0.1 to 2 mg/L (e.g., 0.1 mg/L, 0.2 mg/L, 0.3 mg/L, 0.4 mg/L, 0.5 mg/L, 0.6 mg/L, 0.7 mg/L, 0.8 mg/L, 0.9 mg/L, 1 mg/L, 1.1 mg/L, 1.2 mg/L, 1.3 mg/L, 1.4 mg/L, 1.5 mg/L, 1.6 mg/L, 1.7 mg/L, 1.8 mg/L, 1.9 mg/L, or 2 mg/L, inclusive). The second iron amount may be the same as or different from the first iron amount. In some embodiments, the mycelium mass is in the first growth media for a time period greater than or equal to about 5 hours (e.g., 5 hours, 6 hours, etc.) and the second growth media for a time period greater than or equal to 30 seconds (e.g., 30 seconds, 60 seconds, 120 seconds, etc.). In some embodiments, the second growth media may be provided to the mycelium mass after the complete removal and separation of the first growth media from the mycelium mass. In some embodiments, the second growth media may be provided after only a partial removal and separation of the first growth media from the mycelium mass. In some embodiments, the second growth media may be provided to the first growth media without removal of the first growth media from the mycelium mass. The amount of the second growth media may be equal to, less than, or greater than the original amount of the first growth media. In some embodiments, adding the second growth media may add more nutrients (e.g., iron) to the mycelium mass. Increasing the amount of iron in the second growth media or the first growth media may increase the iron content in the mycelium mass. In some embodiments, the second growth media may be added at various stages in the formation of the mycelium mass growth such as to a fermentation broth. It is understood that the number of growth media used to grow the mycelium mass is not limited to two, and any suitable number of growth media used to deliver nutrients (e.g., iron) may be used.

In some embodiments, a mycelium mass with an enhanced nutritional content may be formed by a process of providing a first growth media having a first iron amount in a range from 0.1 mg/L to 10 mg/L and growing fungal cells in the first growth media such that the fungal cells produce a mycelium mass. The mycelium mass may have an iron content greater than or equal to 5 mg of iron per 100 g of the mycelium mass. In some embodiments, the mycelium mass has an iron content of from about 5 mg of iron per 100 g of mycelium mass to about 15 mg of iron per 100 g of mycelium mass. The process may further include separating the mycelium mass from the first growth media.

The fungal cells can be grown at a temperature in a range from about 25° C. to about 45° C. (e.g., 25° C., 30° C., 35° C., 40° C., or 45° C., inclusive). The fungal cells can be grown in a range from about 12 hours to about 48 hours (e.g., 12 hours, 24 hours, 36 hours, or 48 hours, inclusive). Growing fungal cells can produce a yield of about 5 to about 20 g/L (e.g., 5 g/L, 10 g/L, 15 g/L, or 20 g/L, inclusive) of fungal cell dry weight. The mycelium mass can have a protein content of equal to or greater than about 40 wt % (e.g., 40 wt %, 50 wt %, 60 wt %, 70 wt %, 80 wt %, 90 wt %, or 100 wt %, inclusive) (dry weight). In some embodiments, the mycelium mass may have a protein content of about 50 to about 65% (e.g., 50%, 55%, 60%, or 65%, inclusive) (dry weight). The mycelium mass can have a combined methionine and cysteine content of at least about 25 mg/g crude protein.

In at least some embodiments of growing fungal cells disclosed herein (e.g., growing fungal cells such that the fungal cells produce a mycelium mass), the fungal cells are grown through a submerged fermentation process or in liquid media. Accordingly, embodiments of growing fungal cells (e.g., growing fungal cells such that the fungal cells produce a mycelium mass) described herein are distinguished from processes in which growth occurs on a substrate, such as in solid-state fermentation or surface fermentation.

Fungal cells grown through a submerged fermentation process can be grown either as aggregated masses referred to as pellets, as filamentous mycelium, or as a combination of both pellets and filamentous mycelium. In at least some embodiments of growing fungal cells disclosed herein (e.g., growing fungal cells such that the fungal cells produce a mycelium mass), the fungal cells grow as filamentous mycelium that is free of pellets.

The mycelium mass may then be separated from the growth media. In some embodiments, the mycelium mass may be mixed with food additives or colors. Additives can include vegetable or animal proteins, fats, emulsifiers, thickeners, stabilizers, flavoring, any other suitable additive, or combinations thereof.

In some embodiments, the mycelium mass is a mycelium product that has been exposed to light so as to form an enhanced mycelium product having a vitamin D content. In exposing the mycelium product to the light, a wavelength of the light, a distance to the light, and an exposure time may be varied. The light may have a wavelength in a range from about 100 to about 400 nanometers (e.g., 100 nanometers, 150 nanometers, 200 nanometers, 250 nanometers, 300 nanometers, 350 nanometers, or 400 nanometers, inclusive). The mycelium product may be exposed to the light for a first period of time. In some embodiments, the light may have a wavelength in the Ultraviolet (UV) radiation region. The UV radiation region may include three types of UV rays such as UVA, UVB, and UVC which all have different wavelengths. In some embodiments, the wavelength may be in the UVA region in a range from about 315 to about 400 nanometers (e.g., 315 nanometers, 325 nanometers, 335 nanometers, 345 nanometers, 355 nanometers, 365 nanometers, 375 nanometers, 385 nanometers, 395 nanometers, or 400 nanometers, inclusive). In some embodiments, the wavelength may be in the UVB region in a range from about 280 to about 315 nanometers (e.g., 280 nanometers, 290 nanometers, 300 nanometers, 310 nanometers, or 315 nanometers, inclusive). In some embodiments, the wavelength may be in the UVC region in a range from about 100 to about 280 nanometers (e.g., 100 nanometers, 120 nanometers, 140 nanometers, 160 nanometers, 180 nanometers, 200 nanometers, 220 nanometers, 240 nanometers, 260 nanometers, or 280 nanometers, inclusive). The light may have any suitable light source such as, but not limited to a UVA lightbulb, a UVB lightbulb, a UVC lightbulb or, a UV lamp. In some embodiments, the mycelium product may be exposed to light (e.g., UV light) while the mycelium product is disposed in a vessel (e.g., a fermentation tank), such as by positioning a source of light (e.g., UV light) within the vessel containing the mycelium product. In some embodiments, the mycelium product may be wet and exposed to UV radiation in a transparent conduit (e.g., a glass tube, a transparent container having an inlet and an outlet, etc.) as it is pumped from a tank (e.g., a fermentation tank) to processing (e.g., post-harvest processing). In other embodiments, the mycelium product may be exposed to UV light as it travels on a conveyer (e.g., a conveyor belt or chain) at any point of processing up until packaging. Thus, it is to be understood that a source of light (e.g., UV light) may be located in the same space as mycelium product (e.g., over or near a conveyer or within a vessel containing mycelium product) or located externally to a vessel containing mycelium product (e.g., outside of a conduit carrying mycelium product).

In at least some embodiments comprising exposing mycelium product to light, the exposure does not cause the production of pigmentation in the mycelium product. In at least some instances, the production of pigmentation in mycelium upon exposing the mycelium to light is undesirable. Accordingly, at least some embodiments comprising exposing mycelium product to light that are described herein constitute an improvement over processes involving exposing mycelium to light that result in the production of pigmentation.

The mycelium product is exposed to the light for a first period of time. In some embodiments, the first period of time is in a range from about 1 second to about 300 seconds (e.g., 1 second, 10 seconds, 20 seconds, 30 seconds, 40 seconds, 50 seconds, 60 seconds, 90 seconds, 120 seconds, 150 seconds, 180 seconds, 210 seconds, 240 seconds, 270 seconds, or 300 seconds, inclusive). In some embodiments, the first period of time is in a range from about 25 to about 45 seconds (e.g., 25 seconds, 30 seconds, 35 seconds, 40 seconds, or 45 seconds, inclusive). In some embodiments, the mycelium product is at a distance from a source of the light. In some embodiments, the distance is in a range from about 1 to about 10 centimeters (e.g., 1 centimeter, 2 centimeters, 3 centimeters, 4 centimeters, 5 centimeters, 6 centimeters, 7 centimeters, 8 centimeters, 9 centimeters, or 10 centimeters, inclusive). In some embodiments, the amount of a UV dose exposed to the mycelium product may be varied based on time and intensity of exposure. In such embodiments, the dose may be modeled by Equation 1.

$$U V Dose = U V Intensity [ \frac{μ W}{{cm}^{2}} ] * Exposure Time [ sec ] \qquad [ 1 ]$$

In some embodiments, exposing the mycelium product to the light comprises exposing a first side of the mycelium product to the light for the first period of time. In such embodiments, a second side of the mycelium product may be exposed to the light for a second period of time after the first time period. For example, the mycelium product may be flipped over to the second side (e.g., a back side, or a side orthogonal to the first side) of the mycelium product, which is then exposed to the light, or moved laterally to align the second side (e.g., a second portion of a top side). The second period of time may be in a range from about 1 to about 300 seconds (e.g., 1 second, 10 seconds, 20 seconds, 30 seconds, 40 seconds, 50 seconds, 60 seconds, 90 seconds, 120 seconds, 150 seconds, 180 seconds, 210 seconds, 240 seconds, 270 seconds, or 300 seconds, inclusive). The second period of time may be in a range from about 25 to about 45 seconds (e.g., 25 seconds, 30 seconds, 35 seconds, 40 seconds, or 45 seconds, inclusive). The second period of time may be the same as the first period of time, or different than the first period of time. The second side may be on the same surface as the first side, or on a different surface from the first side. The second side may overlap the first side. The second side may have an area that is larger than, less than, or equal to an area of the first side.

The second side may be exposed to the light in the same wavelength range or region (e.g., UVA, UVB, or UVC) as the first side. The second side may be exposed to the light in a different wavelength range or different region as the first side. The second side may be exposed to light from the same source or a different source as the first side. The second side may be at a distance from the source of light in a range from about 1 to about 10 centimeters (1 centimeters, 2 centimeters, 3 centimeters, 4 centimeters, 5 centimeters, 6 centimeters, 7 centimeters, 8 centimeters, 9 centimeters, or 10 centimeters, inclusive). The second side may be at the same distance or a different distance from the source of light as the first side.

Exposing the mycelium product to the light (e.g., UV radiation) may cause intracellular production of vitamin D in the mycelium product so as to produce an enhanced mycelium product with a vitamin D content. Thus, unnatural fortification of the mycelium product by separately adding vitamin D thereto, is not required. The mycelium product may contain ergosterol, a vitamin D precursor, which may be converted to vitamin D₂ by exposure to UV light.

The vitamin D content of the mycelium product after exposure to the light (e.g., UV light) may be greater than or equal to about 1 microgram per 100 grams of the enhanced mycelium product (e.g., 1 microgram per 100 grams, 2 micrograms per 100 grams, 3 micrograms per 100 grams, 4 micrograms per 100 grams, 5 micrograms per 100 grams, etc.). In some embodiments, the vitamin D content may meet or exceed the RDA for vitamin D in the enhanced mycelium product. The RDA for vitamin D for children 1 to 18 years old, inclusive, may be 15 micrograms. The RDA for vitamin D for adults 19 to 70 years old, inclusive, may be 15 micrograms. The RDA for vitamin D for adults 71 years and older may be 20 micrograms. The RDA for vitamin D for pregnant and breastfeeding women may be 15 micrograms. Thus, in some embodiments, the vitamin D content of the mycelium product after exposure to the light (e.g., UV light) may be about 15 micrograms per 100 g of enhanced mycelium product or about 20 micrograms per 100 g of enhanced mycelium product. In some embodiments, the vitamin D content of the mycelium product after exposure to the light (e.g., UV light) may be greater than about 15 micrograms per 100 g of enhanced mycelium product or greater than about 20 micrograms per 100 g of enhanced mycelium product.

In some embodiments, the vitamin D content of the mycelium product after exposure to the light (e.g., UV light) does not exceed the tolerable daily upper intake level of vitamin D. The tolerable upper intake level of vitamin D for individuals aged 9 years and older may be 100 micrograms. Thus, in some embodiments, the vitamin D content of the mycelium product after exposure to the light (e.g., UV light) may be about 100 micrograms or less per 100 g of enhanced mycelium product.

In some embodiments, the vitamin D content of the mycelium product after exposure to the light (e.g., UV light) may be from about 1 microgram per 100 grams of the enhanced mycelium product to about 1 milligram (i.e., 1,000 micrograms) per 100 grams of the enhanced mycelium product. For example, in some embodiments, the vitamin D content of the mycelium product after exposure to the light (e.g., UV light) may be from about 1 microgram per 100 grams of the enhanced mycelium product to about 100 micrograms per 100 grams of the enhanced mycelium product. In some embodiments, the vitamin D content of the mycelium product after exposure to the light (e.g., UV light) may be from about 1 microgram per 100 grams of the enhanced mycelium product to about 200 micrograms per 100 grams of the enhanced mycelium product. In some embodiments, the vitamin D content of the mycelium product after exposure to the light (e.g., UV light) may be from about 1 microgram per 100 grams of the enhanced mycelium product to about 300 micrograms per 100 grams of the enhanced mycelium product. In some embodiments, the vitamin D content of the mycelium product after exposure to the light (e.g., UV light) may be from about 1 microgram per 100 grams of the enhanced mycelium product to about 400 micrograms per 100 grams of the enhanced mycelium product. In some embodiments, the vitamin D content of the mycelium product after exposure to the light (e.g., UV light) may be from about 1 microgram per 100 grams of the enhanced mycelium product to about 500 micrograms per 100 grams of the enhanced mycelium product. In some embodiments, the vitamin D content of the mycelium product after exposure to the light (e.g., UV light) may be from about 1 microgram per 100 grams of the enhanced mycelium product to about 600 micrograms per 100 grams of the enhanced mycelium product. In some embodiments, the vitamin D content of the mycelium product after exposure to the light (e.g., UV light) may be from about 1 microgram per 100 grams of the enhanced mycelium product to about 700 micrograms per 100 grams of the enhanced mycelium product. In some embodiments, the vitamin D content of the mycelium product after exposure to the light (e.g., UV light) may be from about 1 microgram per 100 grams of the enhanced mycelium product to about 800 micrograms per 100 grams of the enhanced mycelium product. In some embodiments, the vitamin D content of the mycelium product after exposure to the light (e.g., UV light) may be from about 1 microgram per 100 grams of the enhanced mycelium product to about 900 micrograms per 100 grams of the enhanced mycelium product. In some embodiments, the vitamin D content of the mycelium product after exposure to the light (e.g., UV light) may be from about 1 microgram per 100 grams of the enhanced mycelium product to about 5 micrograms per 100 grams of the enhanced mycelium product, from about 1 microgram per 100 grams of the enhanced mycelium product to about 10 micrograms per 100 grams of the enhanced mycelium product, from about 1 microgram per 100 grams of the enhanced mycelium product to about 15 micrograms per 100 grams of the enhanced mycelium product, or from about 1 microgram per 100 grams of the enhanced mycelium product to about 20 micrograms per 100 grams of the enhanced mycelium product, such as about 1 microgram per 100 grams of the enhanced mycelium product, about 2 micrograms per 100 grams of the enhanced mycelium product, about 3 microgram per 100 grams of the enhanced mycelium product, about 4 micrograms per 100 grams of the enhanced mycelium product, about 5 micrograms per 100 grams of the enhanced mycelium product, about 6 micrograms per 100 grams of the enhanced mycelium product, about 7 micrograms per 100 grams of the enhanced mycelium product, about 8 micrograms per 100 grams of the enhanced mycelium product, about 9 micrograms per 100 grams of the enhanced mycelium product, about 10 micrograms per 100 grams of the enhanced mycelium product, about 11 micrograms per 100 grams of the enhanced mycelium product, about 12 micrograms per 100 grams of the enhanced mycelium product, about 13 micrograms per 100 grams of the enhanced mycelium product, about 14 micrograms per 100 grams of the enhanced mycelium product, about 15 micrograms per 100 grams of the enhanced mycelium product, about 16 micrograms per 100 grams of the enhanced mycelium product, about 17 micrograms per 100 grams of the enhanced mycelium product, about 18 micrograms per 100 grams of the enhanced mycelium product, about 19 micrograms per 100 grams of the enhanced mycelium product, or about 20 micrograms per 100 grams of the enhanced mycelium product.

In some embodiments, the mycelium product may be exposed to the UV light for a period of time outside of the range of 1 to 300 seconds. In such embodiments, the vitamin D content may be greater than about 100 micrograms per 100 grams of the enhanced mycelium product (e.g., greater than 1,000 micrograms per 100 grams of the enhanced mycelium product.) In such embodiments, an excessive amount of vitamin D may be toxic to humans, for example, who are mildly vitamin D sufficient. However, such high vitamin D content enhanced mycelium may be used to produce mycelium based edible meat substitutes for animals or severely deficient humans who need a high dose of vitamin D so as to increase their blood vitamin D levels to a normal range in a short amount of time. Such high vitamin D content enhanced mycelium may also be used to produce a vitamin D supplement.

In some embodiments, a mycelium mass with an enhanced nutritional content may be formed by a method that increases both the vitamin D content and the iron content of an enhanced mycelium product.

In some embodiments, exposure of the mycelium product to light (e.g., UV light) may induce intracellular production of vitamin D in the mycelium product to such an extent so as to produce an enhanced mycelium product with a vitamin D content that renders the enhanced mycelium product unfit for human consumption (for example, because its vitamin D content is so high as to create a risk of vitamin D toxicity if consumed by humans). The present disclosure provides approaches to address that concern. In some embodiments, the vitamin D content in an enhanced mycelium product is controlled (e.g., to ensure vitamin D levels that are appropriate for human consumption) by moderating the duration of exposure of the mycelium product to light (e.g., UV light) and/or by moderating the wavelength and/or intensity of the light source. In some embodiments, the duration of exposure of the mycelium product to light (e.g., UV light) is moderated by adjusting and/or controlling the flow rate of a fluid phase containing mycelium product as it is exposed to light (e.g., UV light). In other embodiments, only a portion of a quantity of mycelium product is exposed to light (e.g., UV light) that induces intracellular production of vitamin D in the mycelium product so as to produce an enhanced mycelium product, and that portion is mixed with additional amounts of non-irradiated mycelium product. In some embodiments, the admixture of a portion of mycelium product exposed to light (e.g., UV light) and an amount of non-irradiated mycelium product has, as a whole, a vitamin D content that is low enough to be suitable for human consumption. For example, in some embodiments, such an admixture has a vitamin D content from about 1 microgram per 100 grams of the enhanced mycelium product to about 20 micrograms per 100 grams of the enhanced mycelium product, such as from about 1 microgram per 100 grams of the enhanced mycelium product to about 10 micrograms per 100 grams of the enhanced mycelium product or from about 1 microgram per 100 grams of the enhanced mycelium product to about 15 micrograms per 100 grams of the enhanced mycelium product.

In some embodiments where only a portion of a quantity of mycelium product is exposed to light (e.g., UV light) that induces intracellular production of vitamin D in the mycelium product so as to produce an enhanced mycelium product, that portion of the quantity of mycelium product is in a fluid phase and is routed to an apparatus containing a light source (e.g., a UV light source, such as a UVB light source), exposed to light (e.g., UV light), and combined with remaining non-irradiated mycelium product in a fluid phase. For example, in an embodiment, a portion of a fluid phase containing mycelium is routed from a fermentation tank or other vessel to an apparatus containing a light source (e.g., a UV light source, such as a UVB light source), exposed to light, and recombined with non-irradiated mycelium product in a fluid phase. In some such embodiments, the irradiated portion of the fluid phase is recombined with non-irradiated mycelium product through a static mixture to provide a uniform dispersion of irradiated and non-irradiated mycelium product. In some embodiments, the apparatus containing a light source is a modified version of a device used for sanitizing water with light (e.g., UV light), such as a Sanitron® device. In some embodiments, the amount of fluid-phase mycelium product that is routed to the apparatus and exposed to light (e.g., UV light) is from about 1/40^{th} to about 1/10^{th} of the total amount of mycelium product prepared, such as about 1/40^{th}, 1/35^{th}, 1/30^{th}, 1/25^{th}, 1/20^{th}, 1/15^{th}, or 1/10^{th} of the total amount of mycelium product prepared. For example, in an embodiment where the amount of fluid-phase mycelium product that is routed to the apparatus and exposed to light (e.g., UV light) is 1/10^{th} of the total amount of mycelium product prepared, it is to be understood that 1/10^{th} of the entire volume of fluid phase mycelium product is routed to the apparatus and exposed to light (e.g., UV light), with 9/10^{th} of the entire volume of fluid phase mycelium product remaining non-irradiated. The 1/10^{th} of the entire volume of fluid phase mycelium product that was exposed to light (e.g., UV light) is recombined with the remaining 9/10^{th} of the entire volume of fluid phase mycelium product, providing a volume of fluid phase mycelium product that, as a whole, has a higher vitamin D content compared to the vitamin D content of the volume of fluid phase mycelium product prior to irradiation of the portion of fluid phase mycelium product. In some embodiments, the light source in the apparatus is a UVB light source. In some embodiments, the light source in the apparatus is a UVB light source emitting UVB light having a wavelength that is from about 280 nanometers to about 315 nanometers.

The method 100 may include diluting the mycelium mass to form a diluted mycelium product, at 104. The method 100 may include diluting the mycelium mass with water or any other suitable substance, e.g., an aqueous solution, a growth media, etc. In some embodiments, the method 100 may include diluting the mycelium mass with water having a water volume to form the diluted mycelium product. In some embodiments, water can be added such that a ratio of the water volume to the first volume is in a range from about 0.3:1 to about 19.5:1. In some embodiments, water can be added such that a ratio of the water volume to the first volume is in a range from about 0.35:1 to about 19.5:1. In some embodiments, water can be added such that a ratio of the water volume to the first volume is in a range from about 0.35:1 to about 19:1. In some embodiments, water can be added such that a ratio of the water volume to the first volume is in a range from about 0.3:1 to about 19:1. In some embodiments, water can be added such that a ratio of the water volume to the first volume is in a range from about 1:1 to about 5:1 (e.g., 1:1, 2:1, 3:1, 4:1, or 5:1, inclusive). In some embodiments, the water can be added such that a ratio of the water volume to the first volume is in a range from about 0.5:1 to about 5:1. Other ratios are also contemplated and are within the scope of the present disclosure. In some embodiments, the ratio of the water volume to the first volume is about 3:1. Before dilution, the mycelium can be very fluid, fibrous, and heterogeneous. Diluting the mycelium can make the mycelium more homogenous than undiluted mycelium. This can make it easier to form (e.g., manipulate) and more palatable to cat.

The method 100 may include applying a pressure to the diluted mycelium product while the diluted mycelium product is disposed within a vessel, at 106. The applied pressure may be a pneumatic pressure. The applied pressure may be provided by mechanical force or gravity. The vessel is configured to receive the diluted mycelium product and pressurize the diluted mycelium product. The vessel may be a pressure-rated vessel (e.g., pressure vessel). The pressure-rated vessel can include a container designed to hold liquids, vapors, or gases at a pressure different from the ambient pressure. The pressure may be in a range from about 1 psi to about 100 psi (e.g., 1 psi, 10 psi, 25 psi, 50 psi, 75 psi, or 100 psi, inclusive). In some embodiments, a lower pressure range may be utilized, such as a range of about 1 to about 50 psi (e.g., 1 psi, 10 psi, 20 psi, 30 psi, 40 psi, or 50 psi, inclusive), applied to the diluted mycelium product. In such embodiments, the diluted mycelium product may then be moved to a mechanical press as a second step in a two-step process. In other embodiments, a higher pressure of about 50 to about 100 psi may be applied to the diluted mycelium product to achieve the mechanical pressing function in a one-step process. Gas (e.g., air, nitrogen, oxygen, etc.) from a gas supply manifold may be used to pressurize the vessel.

The method 100 includes selectively expelling the diluted mycelium product into a mold (e.g., cavity) from the vessel, at 108. The diluted mycelium product may be expelled pneumatically, for example, via gas (e.g., air) pressure. The diluted mycelium product may be expelled using mechanical force or by gravity. A conduit may be coupled to an outlet of the vessel, and the mold may be fluidly coupled to the outlet of the vessel via the conduit. The conduit may be any suitable connecting device such as, but not limited to, a flexible hose, a rubber hose, a plastic hose, a plastic tube, a metal tube, an air hose, a chemical hose, or a hydraulic hose. In some embodiments, the conduit may include smooth interior walls for purposes such as, but not limited to, cleanability. The diluted mycelium product can be selectively expelled pneumatically into the mold via the conduit when a first valve is opened. The diluted mycelium product can be selectively expelled by the application of mechanical force or by gravity into the mold via the conduit when a first valve is opened. The conduit may be any suitable size so as to not restrict flow of the diluted mycelium product as it is expelled. The first valve may open in response to the diluted mycelium product being pressurized, for example, once the diluted mycelium product has been pressurized by air pressure within the vessel, the first valve is opened to expel the diluted mycelium product into the mold. The first valve may be an air actuated ball valve, a hand valve, a gate valve, a globe valve, a plug valve, a butterfly valve, a check valve, a diaphragm valve, a pinch valve, a pressure relief valve, a control valve, or any other suitable valve. In some embodiments, the first valve is a manually activated valve, for example, a hand valve. In some embodiments, the first valve is a computer operated valve.

The mold may have a smaller volume than the vessel. The mold can be of various shapes and sizes such as, but not limited to, rectangular, cubic, trapezoidal, triangular, or spherical. For example, the mold can have sidewalls extending from a base. The mold may have a lid configured to selectively enclose the mycelium mass within the mold. The sidewalls can hold the mycelium mass inside the mold. In some embodiments, the sidewalls of the mold are perforated. In some embodiments, the base of the mold can additionally or alternatively be perforated. For example, the base of the mold can have holes or perforations. The holes or perforations may be uniformly spaced apart from one another. The holes or perforations may be periodically spaced. The holes or perforations may be space in a random array. The lid of the mold can additionally or alternatively be perforated. The mold may have complex shapes such as shapes that take the form of animal meats such as chicken breast, beef steaks, pork chops, or any other suitable shape.

In some embodiments, the diluted mycelium product is concurrently expelled into more than one mold. For example, the vessel may be connected to two molds, and the diluted mycelium product may be expelled into both molds at the same time via the conduit. In such embodiments, the conduit may comprise a first hose coupled to a first mold and a second hose coupled to a second mold. In other embodiments, the diluted mycelium product may be expelled into both molds at different times. In some embodiments, more than one diluted mycelium product is concurrently expelled into more than one mold. In other embodiments, more than one diluted mycelium product is expelled into more than one mold at different times. The diluted mycelium product can fill the mold. The diluted mycelium product can be expelled into the mold in less than a minute (e.g., 5 seconds, 10 seconds, 15 seconds, 30 seconds, 45 seconds, or 59 seconds, inclusive). However, other time are also contemplated and are within the scope of the present disclosure.

The method 100 includes expelling water or any other excess moisture from the diluted mycelium product to form a compacted mycelium product, at 110. In some embodiments, a pneumatic expulsion of the diluted mycelium product into the mold having a smaller volume results in the expulsion of water from the diluted mycelium product as it is compacted inside the mold. In some embodiments, expulsion of the diluted mycelium product using mechanical force or gravity into the mold having a smaller volume results in the expulsion of water from the diluted mycelium product as it is compacted inside the mold. The expelled water flows out of the mold via the perforations on the sidewalls, base, or lid of the mold can also force excess moisture from the diluted mycelium product. In some embodiments, the compacted mycelium product may have a moisture content in a range from about 25 to about 95% (e.g., 25%, 30%, 35%, 40%, 45%, 50%, 55%, 60%, 65%, 70%, 75%, 80%, 85%, 90%, or 95% inclusive). In some embodiments, the compacted mycelium product may have a moisture content in a range from about 50 to about 85% (e.g., 50%, 60%, 70%, 80%, or 85%, inclusive). In some embodiments, the compacted mycelium product may have a moisture content in a range from about 70 to about 80% (e.g., 70%, 71%, 72%, 73%, 74%, 75%, 76%, 77%, 78%, 79%, or 80%, inclusive).

In some embodiments, the pressure applied to the diluted mycelium product at operation 106 is in a first direction, and a plurality of fibers of the compacted mycelium mass after expulsion into the mold are aligned in second direction. The first direction can be different from the second direction. In some embodiments, the first direction and the second direction may be substantially orthogonal to each other (e.g., oriented at an angle of 90±15 degrees). In some embodiments, a plurality of fibers of the compacted mycelium mass after expulsion into the mold are substantially aligned perpendicularly to the first direction. In some embodiments, a plurality of fibers of the compacted mycelium mass after expulsion into the mold are substantially aligned perpendicularly to the first direction but in a matrix of mixed directions. Applying a unidirectional force to the diluted mycelium product can result in a more homogenous compacted mycelium product.

A flavorant may be added to the resulting compacted mycelium product. The flavorant can include flavorings or food additives. For example, the flavorant can include an oil, such as a nut-derived oil, vegetable-derived oil, plant-derived oil, and animal-derived oil. The flavorant can include spices (e.g., black pepper, fennel, mustard, nutmeg, cinnamon, ginger, cayenne pepper, clove, etc.). The flavorant can include a flavored powder (e.g., onion powder, garlic powder, barbeque powder, sour cream powder, lemon powder, lime powder, etc.).

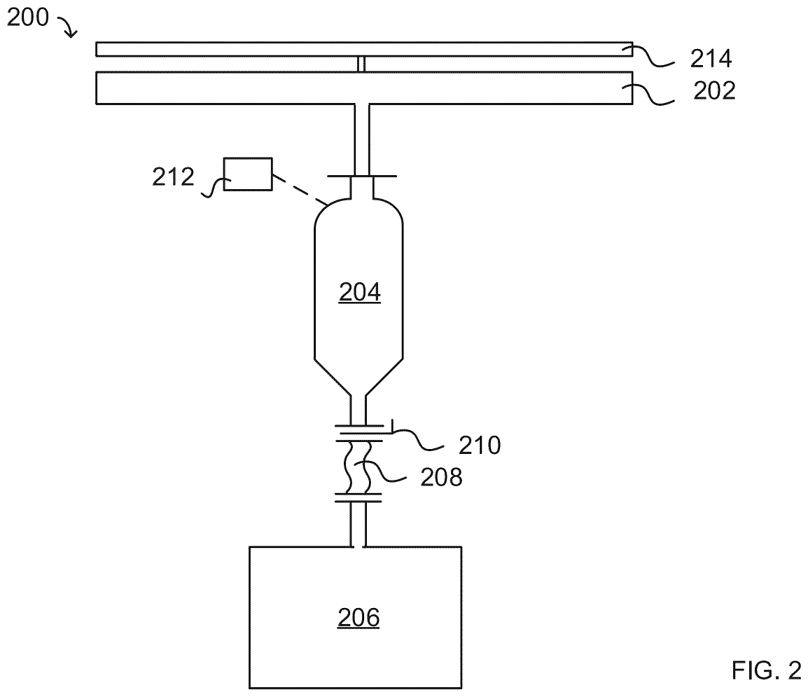

FIG. 2 is a schematic illustration of an example mold filler system 200 (e.g., pneumatic press mold filler system), in accordance with some embodiments. The mold filler system 200 includes a product supply manifold 202 fluidly coupled to a first vessel 204 and configured to communicate (e.g., transfer, move, etc.) a mycelium mass or a diluted mycelium product into the first vessel 204. The mycelium mass may be substantially similar to the mycelium mass discussed in the method 100. In some embodiments, the mycelium mass may be mixed with food additives or colors. Additives can include vegetable or animal proteins, fats, emulsifiers, thickeners, stabilizers, flavoring, any other suitable additive, or combinations thereof.

The mycelium mass may be diluted with water having a water volume before pumping the mycelium mass into the product supply manifold 202, within the product supply manifold 202, or within the first vessel 204 to form a diluted mycelium product. The diluted mycelium product can be substantially similar to the diluted mycelium product discussed in the method 100. In some embodiments, the diluted mycelium product may have a ratio of the water volume to the first volume in a range from about 0.3:1 to about 19.5:1. In some embodiments, the diluted mycelium product may have a ratio of the water volume to the first volume in a range from about 0.35:1 to about 19.5:1. In some embodiments, the diluted mycelium product may have a ratio of the water volume to the first volume in a range from about 0.35:1 to about 19:1. In some embodiments, the diluted mycelium product may have a ratio of the water volume to the first volume in a range from about 0.3:1 to about 19:1. In some embodiments, the diluted mycelium product may have a ratio of the water volume to the first volume in a range from about 1:1 to about 5:1 (e.g., 1:1, 2:1, 3:1, 4:1, or 5:1, inclusive). in some embodiments, the diluted mycelium product may have a ratio of the water volume to the first volume in a range from about 0.5:1 to about 5:1. In some embodiments, the ratio of the water volume to the first volume may be about 3:1. In some embodiments, the mold filler system 200 further includes a water supply configured to provide water to the mold filler system 200.

The first vessel 204 (e.g., similar to the vessel in method 100) may be a pressure-rated vessel and may have a maximum capacity of up to about fifty pounds (e.g., 1 pounds, 5 pounds, 10 pounds, 15 pounds, 25 pounds, 30 pounds, 35 pounds, 40 pounds, 45 pounds, or 50 pounds, inclusive). The first vessel 204 is configured to receive the diluted mycelium product and pressurize the diluted mycelium product.

In some embodiments, a third valve such as an air actuated ball valve, a hand valve, a gate valve, a globe valve, a plug valve, a butterfly valve, a check valve, a diaphragm valve, a pinch valve, a pressure relief valve, a control valve, or any other suitable valve may be located between the product supply manifold 202 and the first vessel 204 in order to selectively communicate (e.g., transfer, move, etc.) the mycelium mass or the diluted mycelium product from the product supply manifold 202 into the first vessel 204 when desired. The third valve may act as a positive shut-off valve from the supply while the first vessel 204 is being pressurized and may prevent the mycelium mass or the diluted mycelium product from going backwards into the supply manifold 202. In some embodiments, the third valve is an air actuated butterfly valve. The third valve may be automated (e.g., operable remotely by a controller) or be manually operated. In some embodiments, the mold filler system 200 further includes a check valve located between the product supply manifold 202 and the first vessel 204 downstream of the third valve. The check valve may be configured to protect pumps and other equipment from damage if pressure changes causes a flow reversal. The check valve may be any suitable valve such as, but not limited to, a ball check valve, a globe valve, a dual plate check valve, a lift check valve, a piston check valve, a stop check valve, a swing check valve, a tilting disc valve, or any other suitable valve. The check valve may be automated (e.g., operable remotely by a controller) or be manually operated.

The mold filler system 200 may further include a first mold 206 (e.g., similar to the mold of method 100) connected to the first vessel 204 through a conduit 208. The conduit 208 may be any suitable connecting device such as, but not limited to, a flexible hose, a rubber hose, a plastic hose, a plastic tube, a metal tube, air hose, a chemical hose, or a hydraulic hose. The conduit 208 can be coupled to an outlet of the first vessel 204 and to the first mold 206 to provide the first mold 206 with the diluted mycelium product from the first vessel 204.

The first mold 206 may have a lid configured to selectively enclose the mycelium mass within the first mold 206. The first mold 206 may have a smaller volume than the first vessel 204. The first mold 206 can be of various shapes and sizes. For example, the first mold 206 can have sidewalls extending from the base. The sidewalls can hold the mycelium mass inside the first mold 206. In some embodiments, the sidewalls of the first mold 206 are perforated. In some embodiments, the base of the first mold 206 can additionally or alternatively be perforated. For example, the base of the first mold 206 can have holes or perforations. The lid of the first mold 206 can additionally or alternatively be perforated or have holes. The first mold 206 may have complex shapes such as shapes that take the form of animal meats such as chicken breast, beef steaks, pork chops, or any other suitable shape.

In some embodiments, a first valve 210 (sometimes referred to as a first vessel first valve) may be disposed between the first vessel 204 and the first mold 206. The first valve 210 may be coupled to the conduit 208 and configured to be selectively opened to expel the pressurized diluted mycelium product into the first mold 206 from the outlet of the first vessel 204. The first valve 210 opens in response to the diluted mycelium mass being pressurized. The first valve 210 can be configured to selectively release the diluted mycelium mass when desired and expel it into the first mold 206. The first valve 210 may be any suitable automatic or manual valve such as an air actuated ball valve, a hand valve, a gate valve, a globe valve, a plug valve, a butterfly valve, a check valve, a diaphragm valve, a pinch valve, a pressure relief valve, a control valve, or any other suitable valve. In some embodiments, the first valve 210 is a hand valve or any other manually operated valve. In some embodiments, the first valve 210 is a computer operated valve. The diluted mycelium product can be expelled into the first mold 206 in less than a minute (e.g., 5 seconds, 10 seconds, 15 seconds, 30 seconds, 45 seconds, or 59 seconds, inclusive).

In some embodiments, the mold filler system 200 further includes a first pneumatic switch 212 configured to apply pneumatic pressure to the mold filler system 200. The first pneumatic switch 212 may include an air in and exhaust exit mechanism. In some embodiments, the mold filler system 200 further includes a gas supply manifold 214 configured to provide a compressed gas (e.g., compressed air) to the mold filler system 200. In some embodiments, a second valve may be located between the gas supply manifold 214 and the first vessel 204 and be configured to selectively communicate (e.g., transfer, move, etc.) the pressurized gas into the first vessel 204. The second valve may be an air actuated ball valve, a hand valve, a gate valve, a globe valve, a plug valve, a butterfly valve, a check valve, a diaphragm valve, a pinch valve, a pressure relief valve, a control valve, or any other suitable valve. In some embodiments, the second valve is an air actuated ball valve.

When switched on, the first pneumatic switch 212 uses gas from the gas supply manifold 214 to open the second valve to apply a pressure to the diluted mycelium product in the first vessel 204. The pressure may be in a range from about 1 to about 100 psi (e.g., 1 psi, 10 psi, 25 psi, 50 psi, 75 psi, or 100 psi, inclusive). In some embodiments, a lower pressure in a range from about 1 to about 50 psi (e.g., 1 psi, 10 psi, 20 psi, 30 psi, 40 psi, or 50 psi, inclusive) may be applied to the diluted mycelium product. In such embodiments, the diluted mycelium product may then be expelled and moved to a mechanical press as a second step in the two-step process. The mechanical press may be configured to expel excess moisture and compact the diluted mycelium product into the desired volume and shape. In such embodiments, the diluted mycelium product may not be expelled into a mold. In other embodiments, a higher pressure at about 50 to about 100 psi may be applied to the diluted mycelium product in the first vessel 204 to achieve the mechanical pressing function without the need for the mechanical press in a one-step process.

When the first valve 210 is opened, the applied pressure may expel the diluted mycelium product from the first vessel 204 through the conduit 208 into the first mold 206. The first mold 206 is fluidly coupled to the outlet of the first vessel 204 via the conduit 208. The first mold 206 may have a smaller volume than the first vessel 204. After entering the first mold 206, the diluted mycelium product may expel water due to the smaller volume and form a compacted mycelium product. In some embodiments, the compacted mycelium product may have a moisture content in a range from about 25 to about 95% (e.g., 25%, 30%, 35%, 40%, 45%, 50%, 55%, 60%, 65%, 70%, 75%, 80%, 85%, 90%, or 95%, inclusive). In some embodiments, the compacted mycelium product may have a moisture content in a range from about 50 to about 85% (e.g., 50%, 60%, 70%, 80%, or 85%, inclusive). In some embodiments, the compacted mycelium product may have a moisture content in a range from about 70 to about 80% (e.g., 70%, 71%, 72%, 73%, 74%, 75%, 76%, 77%, 78%, 79%, or 80%, inclusive). In some embodiments, the perforated sidewalls, the base, or the lid of the first mold 206 may result in the expulsion of moisture as well.

The applied pressure may result in a unidirectional force in a first direction, causing the compacted mycelium product to have fibers aligned in a second direction. In some embodiments, the second direction may be substantially orthogonal (e.g., oriented at an angle of 90±15 degrees) to the first direction. In some embodiments, the fibers of the compacted mycelium product are substantially aligned perpendicularly to the first direction. In some embodiments, the fibers of the compacted mycelium product are substantially aligned perpendicularly to the first direction but in a matrix of mixed directions. The aligned fibers can make the compacted mycelium product more homogenous and provides a texture more similar to meat.

A flavorant may be added to the resulting compacted mycelium product. The flavorant can include flavorings or food additives. For example, the flavorant can include an oil, such as a nut-derived oil, vegetable-derived oil, plant-derived oil, and animal-derived oil. The flavorant can include spices (e.g., black pepper, fennel, mustard, nutmeg, cinnamon, ginger, cayenne pepper, clove, etc.). The flavorant can include a flavored powder (e.g., onion powder, garlic powder, barbeque powder, sour cream powder, lemon powder, lime powder, etc.).

The mold filler system 200 may further include a pressure element coupled to the first vessel 204. The pressure element may be a pressure sensor such as, but not limited to, a potentiometric pressure sensor, an inductive pressure sensor, a capacitive pressure sensor, a piezoelectric pressure sensor, a strain gauge pressure sensor, a variable reluctance pressure sensor, or any other suitable pressure element. The pressure element may be configured to monitor the pressure of the first vessel 204.

In some embodiments, the mold filler system 200 further includes other components typically used in a pneumatic system such as but not limited to a compressor, an air preparation unit, a filter, a regulator, a lubricator, a liquid separator, a pressure gauge, a directional control valve, a machine control component, springs, actuators, pistons, any other suitable component, or combinations thereof. These components may be coupled to or a part of the first pneumatic switch 212. It is understood these components are not shown for purposes of clarity. In some embodiments, the mold filler system 200 further includes an automated electronic system (such as a controller) configured to control any valves or pneumatic switches in the mold filler system 200.

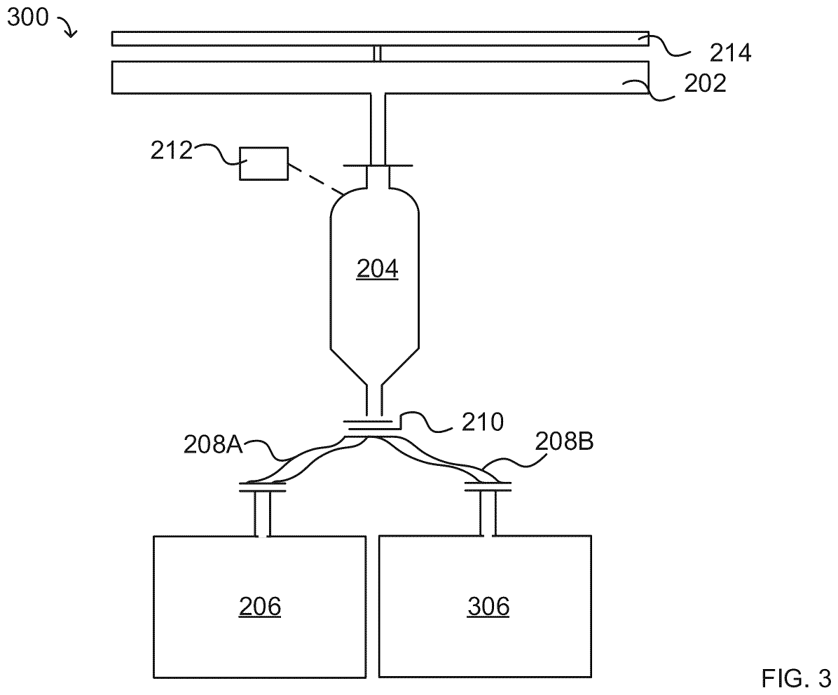

FIG. 3 is a schematic illustration of an example mold filler system 300 (e.g., pneumatic press mold filler system) with two molds, in accordance with some embodiments. It is understood that while two molds are shown, the mold filler system 300 is not limited to two molds and can have any suitable number of molds.

The mold filler system 300 can include the first mold 206 and a second mold 306. The second mold 306 can be of various shapes and sizes. The second mold 306 may have a lid configured to selectively enclose the second mold 306 or its contents. The second mold 306 can have sidewalls extending from the base. The sidewalls can hold the mycelium mass inside the second mold 306. In some embodiments, the sidewalls of the second mold 306 are perforated. In some embodiments, the base of the second mold 306 can additionally or alternatively be perforated. For example, the base of the second mold 306 can have holes or perforations. The lid of the second mold 306 can additionally or alternatively be perforated or have holes. The second mold 306 may have complex shapes such as shapes that take the form of animal meats such as chicken breast, beef steaks, pork chops, or any other suitable shape. The diluted mycelium product can be expelled into the second mold 306 in less than a minute (e.g., 5 seconds, 10 seconds, 15 seconds, 30 seconds, 45 seconds, or 59 seconds, inclusive).

The mold filler system 300 can include the product supply manifold 202 fluidly coupled to the first vessel 204 and configured to communicate (e.g., transfer, move, etc.) the mycelium mass or the diluted mycelium product to the first vessel 204. In some embodiments, the third valve may be located between the product supply manifold 202 and the first vessel 204 and be configured to selectively communicate (e.g., transfer, move, etc.) the diluted mycelium product into the first vessel 204 when opened. In some embodiments, the mold filler system 300 further includes the check valve located between the product supply manifold 202 and the first vessel 204 downstream of the third valve.

In some embodiments, the mycelium mass may be diluted with water having a water volume to form the diluted mycelium product in the product supply manifold 202 or the first vessel 204 with a ratio of water volume to the first volume in a range from in a range from about 0.3:1 to about 19.5:1. In some embodiments, the mycelium mass may be diluted with water having a water volume to form the diluted mycelium product in the product supply manifold 202 or the first vessel 204 with a ratio of water volume to the first volume in a range from in a range from about 0.35:1 to about 19.5:1. In some embodiments, the mycelium mass may be diluted with water having a water volume to form the diluted mycelium product in the product supply manifold 202 or the first vessel 204 with a ratio of water volume to the first volume in a range from in a range from about 0.35:1 to about 19:1. In some embodiments, the mycelium mass may be diluted with water having a water volume to form the diluted mycelium product in the product supply manifold 202 or the first vessel 204 with a ratio of water volume to the first volume in a range from in a range from about 0.3:1 to about 19:1. In some embodiments, the mycelium mass may be diluted with water having a water volume to form the diluted mycelium product in the product supply manifold 202 or the first vessel 204 with a ratio of water volume to the first volume in a range from about 1:1 to about 5:1 (e.g., 1:1, 2:1, 3:1, 4:1, or 5:1, inclusive). in some embodiments, the mycelium mass may be diluted with water having a water volume to form the diluted mycelium product in the product supply manifold 202 or the first vessel 204 with a ratio of water volume to the first volume in a range from about 0.5:1 to about 5:1. The gas supply manifold 214 and the first pneumatic switch 212 may be configured to apply a pressure to the first vessel 204, and the diluted mycelium mass may be expelled when the first valve 210 is opened.

In some embodiments, the conduit 208 comprises a first hose 208A (substantially similar to the conduit in FIG. 2) and a second hose 208B. The first hose 208A and the second hose 208B may be any suitable connecting device such as, but not limited to, a flexible hose, a rubber hose, a plastic hose, a plastic tube, a metal tube, an air hose, a chemical hose, or a hydraulic hose. The first hose 208A is coupled to the first mold 206, and the second hose 208B is coupled to the second mold 306. In the mold filler system 300, a first portion of the diluted mycelium product (e.g., a first diluted mycelium product) may be selectively expelled into the first mold 206 through the first hose 208A, and a second portion of the diluted mycelium product (e.g., a second diluted mycelium product) may be selectively expelled into the second mold 306 through the second hose 208B.

In some embodiments, the first diluted mycelium product and the second diluted mycelium product are expelled into the first mold 206 and second mold 306 concurrently, and two compacted mycelium products are formed in each of the first mold 206 and the second mold 306. In some embodiments, each compacted mycelium product may have a moisture content in a range from about 25 to about 95% (e.g., 25%, 30%, 35%, 40%, 45%, 50%, 55%, 60%, 65%, 70%, 75%, 80%, 85%, 90%, or 95%, inclusive). In some embodiments, each compacted mycelium product may have a moisture content in a range from about 50 to about 85% (e.g., 50%, 60%, 70%, 80%, or 85%, inclusive). In some embodiments, each compacted mycelium product may have a moisture content in a range from about 70 to about 80% (e.g., 70%, 71%, 72%, 73%, 74%, 75%, 76%, 77%, 78%, 79%, or 80%, inclusive). In some embodiments, the first diluted mycelium product and the second diluted mycelium product are expelled at different times.

In some embodiments, the first mold 206 and second mold 306 in the mold filler system 300 may be smaller than the first mold 206 in the mold filler system 200. In some embodiments, the first mold 206 and second mold 306 in the mold filler system 300 may be the same size as the first mold 206 in the mold filler system 200. The first mold 206 and second mold 306 in the mold filler system 300 may be the same size or different sizes from each other. In some embodiments, more or less diluted mycelium product may be disposed in the first vessel 204 in the mold filler system 300 than is disposed in the mold filler system 200. Therefore, in the mold filler system 300, the diluted mycelium product in the first vessel 204 may be concurrently expelled into more than one mold.

Similar to the mold filler system 200, the applied pressure in the first vessel 204 in the mold filler system 300 may result in a unidirectional force in a first direction, causing the compacted mycelium products to have fibers aligned in a second direction. In some embodiments, the second direction may be substantially orthogonal (e.g., oriented at an angle of 90±15 degrees) to the first direction. In some embodiments, the fibers of the compacted mycelium products are substantially aligned perpendicularly to the first direction. In some embodiments, the fibers of the compacted mycelium products are substantially aligned perpendicularly to the first direction but in a matrix of mixed directions. The aligned fibers can make the compacted mycelium products more homogenous and provides textures more similar to meat.

A flavorant may be added to the resulting compacted mycelium products. The flavorant can include flavorings or food additives. For example, the flavorant can include an oil, such as a nut-derived oil, vegetable-derived oil, plant-derived oil, and animal-derived oil. The flavorant can include spices (e.g., black pepper, fennel, mustard, nutmeg, cinnamon, ginger, cayenne pepper, clove, etc.). The flavorant can include a flavored powder (e.g., onion powder, garlic powder, barbeque powder, sour cream powder, lemon powder, lime powder, etc.).

The mold filler system 300 may further include a pressure element coupled to the first vessel 204. The pressure element may be a pressure sensor such as, but not limited to, a potentiometric pressure sensor, an inductive pressure sensor, a capacitive pressure sensor, a piezoelectric pressure sensor, a strain gauge pressure sensor, a variable reluctance pressure sensor, or any other suitable pressure element. The pressure element may be configured to monitor the pressure of the first vessel 204.

In some embodiments, the mold filler system 300 further includes other components typically used in a pneumatic system such as but not limited to a compressor, an air preparation unit, a filter, a regulator, a lubricator, a liquid separator, a pressure gauge, a directional control valve, a machine control component, springs, actuators, pistons, any other suitable component, or combinations thereof. These components may be coupled to or a part of the first pneumatic switch 212. It is understood these components are not shown for purposes of clarity. In some embodiments, the mold filler system 300 further includes an automated electronic system (such as a controller) configured to control any valves or pneumatic switches in the mold filler system 300.

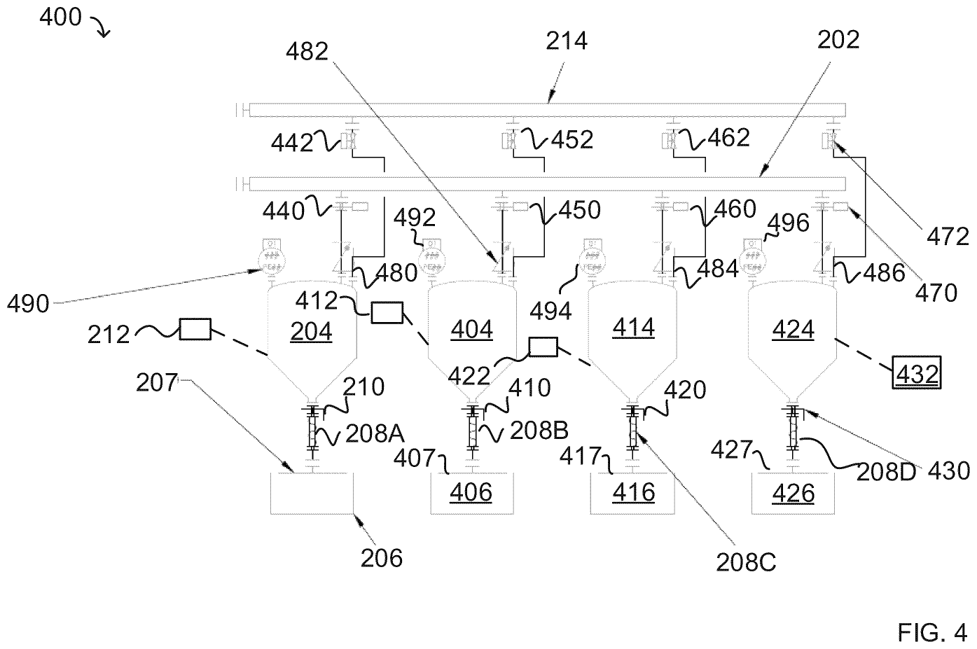

FIG. 4 is a schematic illustration of an example mold filler system 400 (e.g., pneumatic press mold filler system) in which multiple diluted mycelium products are expelled into multiple molds, in accordance with some embodiments. It is understood that while four vessels and four molds are shown, the mold filler system 400 is not limited to four vessels and molds and can have any suitable number of vessels and molds. It is understood that the mold filler system 400 may have a different number of vessels than molds (e.g., four vessels and five molds or any other suitable combination), and some of the vessels may be connected to multiple molds.

The mold filler system 400 is substantially similar to the mold filler system 200 but can include one or more vessels. For example, the mold filler system 400 can include four molds and four vessels. The mold filler system 400 can include the product supply manifold 202 configured to communicate (e.g., transfer, move, etc.) the mycelium mass (e.g., similar to the mycelium mass discussed in the method 100) or the diluted mycelium product to the first vessel 204, a second vessel 404, a third vessel 414, and a fourth vessel 424. The product supply manifold 202 is fluidly coupled to the first vessel 204, the second vessel 404, the third vessel 414, and the fourth vessel 424.

In some embodiments, the mycelium mass may be diluted with water to form the diluted mycelium product in the product supply manifold 202. In other embodiments, the mycelium mass may be diluted with water to form the diluted mycelium product in the first vessel 204, second vessel 404, third vessel 414, and/or the fourth vessel 424. The diluted mycelium product can be substantially similar to the diluted mycelium product discussed in the method 100. The diluted mycelium product may have a ratio of the water volume to the first volume in a range from about 0.3:1 to about 19.5:1. The diluted mycelium product may have a ratio of the water volume to the first volume in a range from about 0.35:1 to about 19.5:1. The diluted mycelium product may have a ratio of the water volume to the first volume in a range from about 0.35:1 to about 19:1. The diluted mycelium product may have a ratio of the water volume to the first volume in a range from about 0.3:1 to about 19:1. The diluted mycelium product may have a ratio of the water volume to the first volume in a range from about 1:1 to about 5:1 (e.g., 1:1, 2:1, 3:1, 4:1, or 5:1, inclusive). The diluted mycelium product may have a ratio of the water volume to the first volume in a range from about 0.5:1 to about 5:1. In some embodiments, the ratio of the water volume to the first volume may be about 3:1. In some embodiments, the mold filler system 400 further includes a water supply configured to provide water to the mold filler system 400.

The second vessel 404, the third vessel 414, and the fourth vessel 424 can be substantially similar to the first vessel 204. The second vessel 404, the third vessel 414, and the fourth vessel 424 may be pressure-rated vessels and may have maximum capacities of up to about fifty pounds (e.g., 1 pounds, 5 pounds, 10 pounds, 15 pounds, 25 pounds, 30 pounds, 35 pounds, 40 pounds, 45 pounds, or 50 pounds, inclusive), and may be capable of holding volumes of mycelium mass in a range from 10 gallon to 25 gallon, inclusive (e.g., 10, 12, 14, 16, 18, 20, 22, 24, or 25 gallons, inclusive). The first vessel 204, the second vessel 404, the third vessel 414, and the fourth vessel 424 may be the same or different sizes. The first vessel 204 is configured to receive a first diluted mycelium product (e.g., a first portion of the diluted mycelium product) from the product supply manifold 202. The second vessel 404 is configured to receive a second diluted mycelium product (e.g., a second portion of the diluted mycelium product) from the product supply manifold 202. The third vessel 414 is configured to receive a third diluted mycelium product (e.g., a third portion of the diluted mycelium product) from the product supply manifold 202. The fourth vessel 424 is configured to receive a fourth diluted mycelium product (e.g., a fourth portion of the diluted mycelium product) from the product supply manifold 202.

In some embodiments, a plurality of third valves 440, 450, 460, and 470 may be placed in between the product supply manifold 202 and the first vessel 204, the second vessel 404, the third vessel 414, and/or the fourth vessel 424, respectively, in order to release the diluted mycelium product from the product supply manifold 202 when desired. For example, one of the plurality of third valves 440 may be located between the product supply manifold 202 and the first vessel 204. Another one of the plurality of third valves 450 may be located between the product supply manifold 202 and the second vessel 404. Another one of the plurality of third valves 460 may be located between the product supply manifold 202 and the third vessel 414. Another one of the plurality of third valves 470 may be located between the product supply manifold 202 and the fourth vessel 424. The third valves 440, 450, 460, and 470 may be any suitable valve such as air actuated ball valves, hand valves, gate valves, globe valves, plug valves, butterfly valves, check valves, diaphragm valves, pinch valves, pressure relief valves, control valves, or any other suitable valves. In particular embodiment, the third valves 440, 450, 460, and/or 470 may include air actuated butterfly valves. The third valves 440, 450, 460, and 470 may be automated (e.g., operable by a controller) or manually operated.

In some embodiments, a plurality of check valves 480, 482, 484, and 486 may be located between the product supply manifold 202 and each of the first vessel 204, the second vessel 404, the third vessel 414, and the fourth vessel 424. The plurality of check valves 480, 482, 484, and 486 may be substantially similar to the check valve in the mold filler system 200. One of the plurality of check valves 480 may be located between the product supply manifold 202 and the first vessel 204 downstream of the corresponding third valve 440. Another one of the plurality of check valves 482 may be located between the product supply manifold 202 and the second vessel 404 downstream of the corresponding third valve 450. Another one of the plurality of check valves 484 may be located between the product supply manifold 202 and the third vessel 414 downstream of the corresponding third valve 460. Another one of the plurality of check valves 486 may be located between the product supply manifold 202 and the fourth vessel 424 downstream of the corresponding third valve 470. Each of the check valves 480, 482, 484, and 486 may be any suitable valve such as, but not limited to, a ball check valve, a globe valve, a dual plate check valve, a lift check valve, a piston check valve, a stop check valve, a swing check valve, a tilting disc valve, or any other suitable valve. The check valves 480, 482, 484, and 486 may be automated (e.g., operable by a controller) or manually operated.

The mold filler system 400 can include the gas supply manifold 214 fluidly coupled to and configured to pressurize the first diluted mycelium product, the second diluted mycelium product, the third diluted mycelium product, and/or the fourth diluted mycelium product within the first vessel 204, the second vessel 404, the third vessel 414, and/or the fourth vessel 424. In some embodiments, the mold filler system 400 further includes a plurality of second valves 442, 452, 462, and 472 located between the gas supply manifold 214 and the first vessel 204, the second vessel 404, the third vessel 414, and the fourth vessel 424. One of the plurality of second valves 442 is located between the gas supply manifold 214 and the first vessel 204. Another one of the plurality of second valves 452 is located between the gas supply manifold 214 and the second vessel 404. Another one of the plurality of second valves 462 is located between the gas supply manifold 214 and the third vessel 414. Another one of the plurality of second valves is located between the gas supply manifold 214 and the fourth vessel 424. Each second valve 442, 452, 462, and 472 is configured to be selectively opened to communicate (e.g., transfer, move, etc.) the pressurized gas into each vessel. The second valves 442, 452, 462, and 472 may be air actuated ball valves, hand valves, gate valves, globe valves, plug valves, butterfly valves, check valves, diaphragm valves, pinch valves, pressure relief valves, control valves, or any other suitable valves. In some embodiments, the second valves 442, 452, 462, and 472 are air actuated ball valves.

The mold filler system 400 can include the first mold 206, a second mold 406, a third mold 416, and a fourth mold 426. The second mold 406, the third mold 416, and the fourth mold 426 can be of various shapes and sizes. The first mold 206, the second mold 406, the third mold 416, and the fourth mold 426 may be the same or different sizes as each other. The first mold 206, the second mold 406, the third mold 416, and the fourth mold 426 may have a first lid 207, a second lid 407, a third lid 417, and a fourth lid 427, respectively configured to selectively enclose each mold or its contents. The second mold 406, the third mold 416, and the fourth mold 426 can have sidewalls extending from the base. The sidewalls can hold the mycelium mass inside the second mold 406, the third mold 416, and the fourth mold 426. In some embodiments, the sidewalls of the second mold 406, the third mold 416, and the fourth mold 426 are perforated. In some embodiments, the bases of the second mold 406, the third mold 416, and the fourth mold 426 can additionally or alternatively be perforated. For example, the bases of the second mold 406, the third mold 416, and the fourth mold 426 can have holes or perforations. The first lid 207, the second lid 407, the third lid 417, and the fourth lid 427 can additionally or alternatively be perforated or have holes. The second mold 406, the third mold 416, and the fourth mold 426 may have complex shapes such as shapes that take the form of animal meats such as chicken breast, beef steaks, pork chops, or any other suitable shape. The diluted mycelium product can be expelled into the second mold 406, the third mold 416, and/or the fourth mold 426 in less than a minute (e.g., 5 seconds, 10 seconds, 15 seconds, 30 seconds, 45 seconds, or 59 seconds, inclusive).

The mold filler system 400 includes a first hose 208A, a second hose 208B, a third hose 208C, and a fourth hose 208D, which fluidly couple the first vessel 204, the second vessel 404, the third vessel 414, and the fourth vessel 424 to the corresponding first mold 206, the second mold 406, the third mold 416, and the fourth mold 426, respectively. The first hose 208A, the second hose 208B, the third hose 208C, and the fourth hose 208D may be any suitable connecting device such as, but not limited to, a flexible hose, a rubber hose, a plastic hose, a plastic tube, a metal tube, an air hose, a chemical hose, or a hydraulic hose.

The mold filler system 400 can include the first pneumatic switch 212 coupled to the gas supply manifold 214 and configured to open the second valve 442 to apply pressure to the first diluted mycelium product in the first vessel 204. The applied pressure may be pneumatic. The first valve 210 (sometimes referred to as the first vessel first valve) is disposed between the first vessel 204 and the first mold 206. The first valve 210 fluidly couples the first vessel 204 to the first mold 206 and can be configured to be selectively opened to communicate (e.g., transfer, move, etc.) the pressurized first diluted mycelium product into the first mold 206 through the first hose 208A to form a first compacted mycelium product. In some embodiments, the first compacted mycelium product may have a moisture content in a range from about 25 to about 95% (e.g., 25%, 30%, 35%, 40%, 45%, 50%, 55%, 60%, 65%, 70%, 75%, 80%, 85%, 90%, or 95%, inclusive). In some embodiments, the first compacted mycelium product may have a moisture content in a range from about 50 to about 85% (e.g., 50%, 60%, 70%, 80%, or 85%, inclusive). In some embodiments, the first compacted mycelium product may have a moisture content in a range from about 70 to about 80% (e.g., 70%, 71%, 72%, 73%, 74%, 75%, 76%, 77%, 78%, 79%, or 80%, inclusive). After entering the first mold 206, the diluted mycelium product may expel water in the smaller volume.

The mold filler system 400 can include a second pneumatic switch 412. The second pneumatic switch 412 can be coupled to the gas supply manifold 214. The second pneumatic switch 412 may include an air in and exhaust exit mechanism. When switched on, the second pneumatic switch 412 uses air from the gas supply manifold 214 to open the second valve 452 to apply pneumatic pressure to the second diluted mycelium product in the second vessel 404. The applied pressure may be a pneumatic pressure, for example, exerted by pressurized gas (e.g., air, nitrogen, oxygen, etc.) being communicated (e.g., transferred, moved, etc.) into the first, second, third, or fourth vessels 204, 404, 414, 424, respectively. The pressure may be in a range from about 1 to about 100 psi (e.g., 1 psi, 10 psi, 25 psi, 50 psi, 75 psi, or 100 psi, inclusive). In some embodiments, a lower pressure in a range from about 1 to about 50 psi (e.g., 1 psi, 10 psi, 20 psi, 30 psi, 40 psi, or 50 psi, inclusive) may be applied to the second diluted mycelium product. In such embodiments, the second diluted mycelium product may then be selectively expelled into the molds 206, 406, 416, 426, respectively, and then, the molds 206, 406, 416, 426 are moved to a mechanical press to apply mechanical pressure on the diluted mycelium product contained within the molds 206, 406, 416, 426 as a second step in the two-step process. The mechanical press may be configured to expel excess moisture and compact the second diluted mycelium product into the desired volume and shape. In other embodiments, a higher pressure at about 100 psi may be applied to the second diluted mycelium product in the second vessel 404 to achieve the mechanical pressing function without the need for the mechanical press in a one-step process.

The first valve 410 (sometimes referred to as a second vessel first valve) is disposed between the second vessel 404 and the second mold 406. The first valve 410 fluidly couples the second vessel 404 to the second mold 406 and can be configured to be selectively opened to communicate (e.g., transfer, move, etc.) the pressurized second diluted mycelium product into the second mold 406 through the second hose 208B. The first valve 410 opens in response to the second diluted mycelium mass being pressurized. The first valve 410 may be any suitable automatic or manual valve such as an air actuated ball valve, a hand valve, a gate valve, a globe valve, a plug valve, a butterfly valve, a check valve, a diaphragm valve, a pinch valve, a pressure relief valve, a control valve, or any other suitable valve. The first valve 410 may be the same as or different from the first valve 210.

When the first valve 410 is opened, the applied pressure is expelled the second diluted mycelium product from the second vessel 404 through the second hose 208B to the second mold 406. After entering the second mold 406, the second diluted mycelium product may expel water to the smaller volume to form a second compacted mycelium product. In some embodiments, the second compacted mycelium product may have a moisture content in a range from about 25 to about 95% (e.g., 25%, 30%, 35%, 40%, 45%, 50%, 55%, 60%, 65%, 70%, 75%, 80%, 85%, 90%, or 95%, inclusive). In some embodiments, the second compacted mycelium product may have a moisture content in a range from about 50 to about 85% (e.g., 50%, 60%, 70%, 80%, or 85%, inclusive). In some embodiments, the second compacted mycelium product may have a moisture content in a range from about 70 to about 80% (e.g., 70%, 71%, 72%, 73%, 74%, 75%, 76%, 77%, 78%, 79%, or 80%, inclusive).

The mold filler system 400 can include a third pneumatic switch 422. The third pneumatic switch 422 can be coupled to the gas supply manifold 214. The third pneumatic switch 422 may include an air in and exhaust exit mechanism. When switched on, the third pneumatic switch 422 may use air from the gas supply manifold 214 to open the second valve 462 to apply pneumatic pressure to the second diluted mycelium product in the second vessel 404. The applied pressure may be pneumatic. The applied pressure may result from mechanical force or gravity. The pressure may be in a range from about 1 to about 100 psi (e.g., 1 psi, 10 psi, 25 psi, 50 psi, 75 psi, or 100 psi, inclusive). In some embodiments, a lower pressure in a range from about 1 to about 50 psi (e.g., 1 psi, 10 psi, 20 psi, 30 psi, 40 psi, or 50 psi, inclusive) may be applied to the third diluted mycelium product. In such embodiments, the third diluted mycelium product may then be selectively expelled and moved to a mechanical press as a second step in the two-step process. The mechanical press may be configured to expel excess moisture and compact the third diluted mycelium product into the desired volume and shape. In other embodiments, a higher pressure at about 100 psi may be applied to the third diluted mycelium product in the third vessel 414 to achieve the mechanical pressing function without the need for the mechanical press in a one-step process.

The first valve 420 (sometimes referred to as a third vessel first valve) is disposed between the third vessel 414 and the third mold 416. The first valve 420 fluidly couples the third vessel 414 to the third mold 416 and can be configured to be selectively opened to communicate (e.g., transfer, move, etc.) the pressurized third diluted mycelium product into the third mold 416 through the third hose 208C. The first valve 420 may be configured to open in response to the third diluted mycelium mass being pressurized. The first valve 420 may be any suitable automatic or manual valve such as an air actuated ball valve, a hand valve, a gate valve, a globe valve, a plug valve, a butterfly valve, a check valve, a diaphragm valve, a pinch valve, a pressure relief valve, a control valve, or any other suitable valve. The first valve 420 may be the same as or different from the first valve 210 or the first valve 410.

When the first valve 420 is opened, the applied pressure expels the third diluted mycelium product from the third vessel 414 through the third hose 208C to the third mold 416. After entering the third mold 416, the third diluted mycelium product may expel water to the smaller volume to form a third compacted mycelium product. In some embodiments, the third compacted mycelium product may have a moisture content in a range from about 25 to about 95% (e.g., 25%, 30%, 35%, 40%, 45%, 50%, 55%, 60%, 65%, 70%, 75%, 80%, 85%, 90%, or 95%, inclusive). In some embodiments, the third compacted mycelium product may have a moisture content in a range from about 50 to about 85% (e.g., 50%, 60%, 70%, 80%, or 85%, inclusive). In some embodiments, the third compacted mycelium product may have a moisture content in a range form about 70 to about 80% (e.g., 70%, 71%, 72%, 73%, 74%, 75%, 76%, 77%, 78%, 79%, or 80%, inclusive).

The mold filler system 400 can include a fourth pneumatic switch 432. The fourth pneumatic switch 432 can be coupled to the gas supply manifold 214. The fourth pneumatic switch 432 may include an air in and exhaust exit mechanism. When switched on, the fourth pneumatic switch 432 uses air from the gas supply manifold 214 to open the second valve 472 to apply pneumatic pressure to the fourth diluted mycelium product in the fourth vessel 424. The applied pressure may be pneumatic. The applied pressure may be from mechanical force or gravity. The pressure may be in a range from about 1 to about 100 psi (e.g., 1 psi, 10 psi, 25 psi, 50 psi, 75 psi, or 100 psi, inclusive). In some embodiments, a lower pressure in a range from about 1 to about 50 psi (e.g., 1 psi, 10 psi, 20 psi, 30 psi, 40 psi, or 50 psi, inclusive) may be applied to the fourth diluted mycelium product. In such embodiments, the fourth diluted mycelium product may then be selectively expelled and moved to a mechanical press as a second step in the two-step process. The mechanical press may be configured to expel excess moisture and compact the second diluted mycelium product into the desired volume and shape. In other embodiments, a higher pressure at about 100 psi may be applied to the fourth diluted mycelium product in the fourth vessel 424 to achieve the mechanical pressing function without the need for the mechanical press in a one-step process.

The first valve 430 (sometimes referred to as a fourth vessel first valve) is disposed between the fourth vessel 424 and the fourth mold 426. The first valve 430 fluidly couples the fourth vessel 424 to the fourth mold 426 and can be configured to be selectively opened to communicate (e.g., transfer, move, etc.) the pressurized fourth diluted mycelium product into the fourth mold 426 through the fourth hose 208D. The first valve 430 opens in response to the fourth diluted mycelium mass being pressurized. The first valve 430 may be any suitable automatic or manual valve such as an air actuated ball valve, a hand valve, a gate valve, a globe valve, a plug valve, a butterfly valve, a check valve, a diaphragm valve, a pinch valve, a pressure relief valve, a control valve, or any other suitable valve. The first valve 430 may be the same as or different from the first valve 210, the first valve 410, and/or the first valve 420.

When the first valve 430 is opened, the applied pressure may selectively expel the fourth diluted mycelium product from the fourth vessel 424 through the fourth hose 208D to the fourth mold 426. After entering the fourth mold 426, the fourth diluted mycelium product may expel water to the smaller volume to form a fourth compacted mycelium product. In some embodiments, the fourth compacted mycelium product may have a moisture content in a range from about 25 to about 95% (e.g., 25%, 30%, 35%, 40%, 45%, 50%, 55%, 60%, 65%, 70%, 75%, 80%, 85%, 90%, or 95%, inclusive). In some embodiments, the fourth compacted mycelium product may have a moisture content in a range from about 50 to about 85% (e.g., 50%, 60%, 70%, 80%, or 85%, inclusive). In some embodiments, the fourth compacted mycelium product may have a moisture content in a range from about 70 to about 80% (e.g., 70%, 71%, 72%, 73%, 74%, 75%, 76%, 77%, 78%, 79%, or 80%, inclusive).

The applied pressure in the first vessel 204, the second vessel 404, the third vessel 414, and/or the fourth vessel 424 may result in a unidirectional force in a first direction, causing the compacted mycelium products to have fibers aligned in a second direction. In some embodiments, the second direction may be substantially orthogonal (e.g., oriented at an angle of 90±15 degrees) to the first direction. In some embodiments, the fibers of the compacted mycelium products are substantially aligned perpendicularly to the first direction. In some embodiments, the fibers of the compacted mycelium products are substantially aligned perpendicularly to the first direction but in a matrix of mixed directions. The aligned fibers can make the compacted mycelium products more homogenous and provides textures more similar to meat.

A flavorant may be added to the resulting compacted mycelium products. The flavorant can include flavorings or food additives. For example, the flavorant can include an oil, such as a nut-derived oil, vegetable-derived oil, plant-derived oil, and animal-derived oil. The flavorant can include spices (e.g., black pepper, fennel, mustard, nutmeg, cinnamon, ginger, cayenne pepper, clove, etc.). The flavorant can include a flavored powder (e.g., onion powder, garlic powder, barbeque powder, sour cream powder, lemon powder, lime powder, etc.).

The mold filler system 400 may further include a plurality of pressure elements 490, 492, 494, and/or 496 coupled to the first vessel 204, the second vessel 404, the third vessel 414, and the fourth vessel 424, respectively. The pressure elements may be pressure sensors such as, but not limited to, potentiometric pressure sensors, inductive pressure sensors, capacitive pressure sensors, piezoelectric pressure sensors, strain gauge pressure sensors, variable reluctance pressure sensors, or any other suitable pressure element. The pressure elements 490, 492, 494, and/or 496 may be configured to monitor the pressure of each of the first vessel 204, the second vessel 404, the third vessel 414, and the fourth vessel 424, respectively.

In some embodiments, the mold filler system 400 further includes other components typically used in a pneumatic system such as but not limited to a compressor, an air preparation unit, a filter, a regulator, a lubricator, a liquid separator, a pressure gauge, a directional control valve, a machine control component, springs, actuators, pistons, any other suitable component, or combinations thereof. These components may be coupled to, or be a part of the first pneumatic switch 212, the second pneumatic switch 412, the third pneumatic switch 422, and/or the fourth pneumatic switch 432. It is understood these while components are not shown for purposes of clarity, various embodiments of pneumatic switches 212, 412, 422, 432 are contemplated in which one or more the aforementioned components are includes in the one or more of the pneumatic switches 212, 412, 422, 432. In some embodiments, the mold filler system 400 further includes an automated electronic system (such as a controller) configured to control any valves or pneumatic switches in the mold filler system 400.

In the mold filler system 400, same or different volumes of the diluted mycelium product can be concurrently expelled into more than one mold. For example, diluted mycelium products disposed in the first vessel 204, the second vessel 404, the third vessel 414, and the fourth vessel 424 may be expelled into the first mold 206, the second mold 406, the third mold 416, and the fourth mold 426, respectively, at the same time or different times. Therefore, the mold filler system 400 is scalable in a manufacturing context in terms of efficiency.

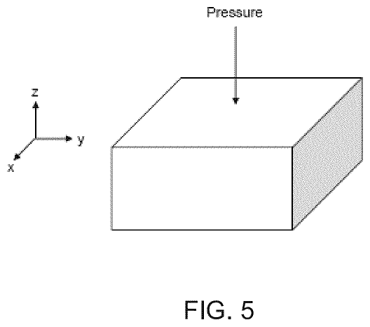

FIG. 5 is a perspective view of a mycelium block. In some embodiments, a mycelium mass is oriented in a mold in an x-y plane and the uniaxial pressure is applied in a z-direction. The pressure can be applied along the z-direction and the mycelium mass is oriented in the mold in the x-y plane. The mycelium block can be formed using uniaxial pressure and fixed boundaries. In some embodiments, the pressure of the uniaxial pressure is in a range from 1 psi to 100 psi (e.g., 1 psi, 5 psi, 10 psi, 20 psi, 30 psi, 40 psi, 50 psi, 60 psi, 70 psi, 80 psi, 90 psi, or 100 psi, inclusive).

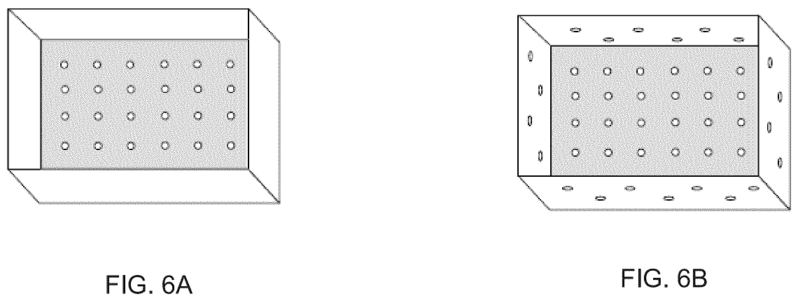

FIG. 6A is a perspective view of a mold with a perforated base. The base can include perforations (e.g., holes, slits, gaps, openings, etc.). The perforations can be arranged in a pattern (e.g., regularly spaced, periodic, randomly spaced, etc.). The perforations can allow moisture to be separated from a mycelium mass. The perforations can allow moisture to be separated from the mycelium mass when the uniaxial pressure is applied. The mold can be made of stainless steel or any other suitable material.

FIG. 6B illustrates a perspective view of a mold with a perforated base and perforated sidewalls. The base and the sidewalls can include perforations (e.g., holes, slits, gaps, openings, etc.). The perforations can be arranged in a pattern (e.g., regularly spaced, periodic, randomly spaced, etc.). The perforations can allow moisture to be expelled from the mycelium mass to form a compacted mycelium product. The perforations can allow moisture to be separated from a mycelium mass when the uniaxial pressure is applied. The mold can be made of stainless steel or any other suitable material. The base and the sidewalls can be made of different materials.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and tables in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

As used herein, the singular forms “a”, “an”, and “the” include plural referents unless the context clearly dictates otherwise. Thus, for example, the term “a member” is intended to mean a single member or a combination of members, “a material” is intended to mean one or more materials, or a combination thereof.

As used herein, the terms “about,” and “approximately,” generally mean plus or minus 10% of the stated value. For example, about 0.5 would include 0.45 and 0.55, about 10 would include 9 to 11, about 1000 would include 900 to 1100.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and tables in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method of providing an edible meat substitute product, comprising:
providing a mycelium mass having a volume;
diluting the mycelium mass with water having a water volume so as to provide a diluted mycelium product,
applying a pressure to the diluted mycelium product, the diluted mycelium product disposed within a vessel;
selectively expelling the diluted mycelium product from the vessel into a mold; and
expelling water from the diluted mycelium product to provide a compacted mycelium product.

2. The method of claim 1, wherein applying the pressure comprises applying a pneumatic pressure to the diluted mycelium product.

3. The method of claim 1, wherein the diluted mycelium product is pressurized in the vessel via the pneumatic pressure before expelling the diluted mycelium mass into the mold.

4. The method of claim 1, wherein the diluted mycelium product is selectively expelled from the vessel via a valve.

5. The method of claim 1, wherein the mold comprises perforated sidewalls.

6. The method of claim 1, wherein the pressure is applied in a first direction and a plurality of fibers of the compacted mycelium product are aligned in a second direction, wherein the first direction and the second direction are substantially orthogonal to each other.

7. The method of claim 1, wherein the pressure is in a range from 1 to 100 psi.

8. The method of claim 1, wherein the compacted mycelium has a moisture content in a range from 50 to 85%.

9. The method of claim 1, wherein the ratio of the water volume to the volume is in a range from 0.5:1 to 5:1.

10. The method of claim 1, wherein the mycelium mass is a fungal mycelium comprising fungi from the genus Neurospora.

11. The method of claim 1, wherein the mycelium mass is a fungal mycelium comprising fungi from the species Neurospora crassa.

12. The method of claim 1, wherein the mycelium mass has a vitamin D content of from about 1 microgram per 100 grams of the enhanced mycelium product to about 1,000 micrograms per 100 grams of the enhanced mycelium product.

13. The method of claim 1, wherein the mycelium mass has an iron content of from 5 mg of iron per 100 g of mycelium mass to 15 mg of iron per 100 g of mycelium mass.

14. An apparatus for providing an edible meat substitute, comprising:
a vessel configured to receive a diluted mycelium product and pressurize the diluted mycelium product;
a conduit coupled to an outlet of the vessel;
a mold fluidly coupled to the outlet of the vessel via the conduit; and
a valve coupled to the conduit and configured to be selectively opened to expel the pressurized diluted mycelium product into the mold.

15. The apparatus of claim 14, further comprising:
a gas supply manifold fluidly coupled to the vessel and configured to pressurize the diluted mycelium product within the vessel, the pressure being a pneumatic pressure.

16. The apparatus of claim 15, wherein the valve is configured to be selectively opened in response to the diluted mycelium product being pressurized to a pressure in a range from 1 psi to 100 psi.

17. The apparatus of claim 15, further comprising:
a second valve located between the gas supply manifold and the vessel, the second valve configured to be selectively opened to communicate the pressurized gas into the vessel.

18. The apparatus of claim 14, further comprising:
a product supply manifold fluidly coupled to the vessel and configured to communicate the diluted mycelium product into the vessel; and
a third valve located between the product supply manifold and the vessel and configured to selectively communicate the diluted mycelium product into the vessel.

19. The apparatus of claim 18, further comprising a check valve located between the product supply manifold and the vessel downstream of the third valve.

20. The apparatus of claim 14, further comprising:
a second mold,
wherein the conduit comprises a first hose coupled to the first mold and a second hose coupled to the second mold.

21. The apparatus of claim 14, wherein the mold is enclosed.

22. The apparatus of claim 14, wherein the diluted mycelium product is a fungal mycelium comprising fungi from the genus Neurospora.

23. The apparatus of claim 22, wherein the diluted mycelium product is a fungal mycelium comprising fungi from the species Neurospora crassa.

24. A system for preparing an edible meat substitute comprising:
a product supply manifold;
a first vessel configured to receive a first diluted mycelium product from the product supply manifold;
a second vessel configured to receive a second diluted mycelium product from the product supply manifold;
a gas supply manifold configured to provide pressurized gas to the first vessel and the second vessel so as to pressurize the first diluted mycelium product and the second diluted mycelium product, respectively;
a first mold fluidly coupled to the first vessel via a first vessel first valve; and
a second mold fluidly coupled to the second vessel via a second vessel first valve,
wherein the first vessel first valve and the second vessel first valve are configured to be selectively opened to communicate the pressurized first diluted mycelium product into the first mold, and the pressurized second diluted mycelium product into the second mold, respectively.

25. The system of claim 24, wherein the first vessel first valve and the second vessel first valve are configured to be selectively opened in response to the diluted mycelium product being pressurized to a pressure in a range from 1 psi to 100 psi.

26. The system of claim 24, further comprising:
a plurality of second valves, one of the plurality of second valves located between the gas supply manifold and the first vessel and another of the plurality of second valves located between the gas supply manifold and the second vessel, each of the plurality of second valves configured to be selectively opened to communicate the pressurized gas into the first vessel and the second vessel, respectively.

27. The system of claim 24, further comprising:
a plurality of third valves, one of the plurality of third valves located between the product supply manifold and the first vessel and another of the plurality of third valves located between the product supply manifold and the second vessel, each of the plurality of third valves configured to be selectively opened to communicate the first diluted mycelium product and the second diluted mycelium product into the first vessel and the second vessel, respectively.

28. The system of claim 27, further comprising a check valve located between the product supply manifold and each of the first vessel and the second vessel downstream of the corresponding third valve.

29. The system of claim 24, wherein the first diluted mycelium product and/or the second diluted mycelium product is a fungal mycelium comprising fungi from the genus Neurospora.

30. The system of claim 24, wherein the first diluted mycelium product and/or the second diluted mycelium product is a fungal mycelium comprising fungi from the species Neurospora crassa.

31. An edible composition comprising:
a compacted, homogeneous mycelium product, wherein
the mycelium product is a fungal mycelium comprising fungi from the genus Neurospora, and
the homogeneous mycelium product comprises a plurality of aligned fibers.

32. The edible composition of claim 31, wherein the mycelium mass is a fungal mycelium comprising fungi from the species Neurospora crassa.

33. The edible composition of claim 31, wherein the mycelium mass has a vitamin D content of from about 1 microgram per 100 grams of the enhanced mycelium product to about 1,000 micrograms per 100 grams of the enhanced mycelium product.

34. The edible composition of claim 31, wherein the mycelium mass has an iron content of from 5 mg of iron per 100 g of mycelium mass to 15 mg of iron per 100 g of mycelium mass.
